(19) United States
(12) Patent Application Publication
(10) Pub. No.: US 2020/0167309 A1
(43) Pub. Date: May 28, 2020

(54) RECONFIGURABLE FABRIC CONFIGURATION USING SPATIAL AND TEMPORAL ROUTING

(71) Applicant: Wave Computing, Inc., Santa Clara, CA (US)

(72) Inventor: Christopher John Nicol, Campbell, CA (US)

(21) Appl. No.: 16/697,571

(22) Filed: Nov. 27, 2019

Related U.S. Application Data
(63) Continuation-in-part of application No. 16/104,586, filed on Aug. 17, 2018.
(60) Provisional application No. 62/907,907, filed on Sep. 30, 2019.
(60) Provisional application No. 62/898,770, filed on Sep. 11, 2019.
(60) Provisional application No. 62/898,114, filed on Sep. 10, 2019.
(60) Provisional application No. 62/893,970, filed on Aug. 30, 2019.
(60) Provisional application No. 62/894,002, filed on Aug. 30, 2019.
(60) Provisional application No. 62/887,713, filed on Aug. 16, 2019.
(60) Provisional application No. 62/887,722, filed on Aug. 16, 2019.
(60) Provisional application No. 62/882,175, filed on Aug. 2, 2019.
(60) Provisional application No. 62/874,022, filed on Jul. 15, 2019.
(60) Provisional application No. 62/857,925, filed on Jun. 6, 2019.
(60) Provisional application No. 62/856,490, filed on Jun. 3, 2019.
(60) Provisional application No. 62/850,059, filed on May 20, 2019.
(60) Provisional application No. 62/827,333, filed on Apr. 1, 2019.
(60) Provisional application No. 62/802,307, filed on Feb. 7, 2019.
(60) Provisional application No. 62/800,432, filed on Feb. 2, 2019.
(60) Provisional application No. 62/773,486, filed on Nov. 30, 2018.
(60) Provisional application No. 62/694,984, filed on Jul. 7, 2018.
(60) Provisional application No. 62/692,993, filed on Jul. 2, 2018.
(60) Provisional application No. 62/679,046, filed on Jun. 1, 2018.
(60) Provisional application No. 62/679,172, filed on Jun. 1, 2018.
(60) Provisional application No. 62/650,425, filed on Mar. 30, 2018.
(60) Provisional application No. 62/650,758, filed on Mar. 30, 2018.
(60) Provisional application No. 62/637,614, filed on Mar. 2, 2018.
(60) Provisional application No. 62/636,309, filed on Feb. 28, 2018.
(60) Provisional application No. 62/611,600, filed on Dec. 29, 2017.
(60) Provisional application No. 62/611,588, filed on Dec. 29, 2017.
(60) Provisional application No. 62/594,563, filed on Dec. 5, 2017.
(60) Provisional application No. 62/594,582, filed on Dec. 5, 2017.
(60) Provisional application No. 62/579,616, filed on Oct. 31, 2017.
(60) Provisional application No. 62/577,902, filed on Oct. 27, 2017.
(60) Provisional application No. 62/547,769, filed on Aug. 19, 2017.

(51) Int. Cl. G06F 15/78

(52) U.S. Cl. CPC G06F 15/7867

(57) ABSTRACT

Techniques for reconfigurable fabric configuration using spatial and temporal routing are disclosed. A plurality of clusters within a reconfigurable fabric is allocated, where the plurality of clusters is configured to execute one or more functions. A first spatial routing and a first temporal routing through the reconfigurable fabric are calculated. A second spatial routing and a second temporal routing through the reconfigurable fabric are calculated. The first and second spatial routings and the first and second temporal routings are optimized. The one or more functions are executed using routings that were optimized. The first spatial routing and the second spatial routing enable a logical connection for data transfer between at least two clusters of the plurality of clusters. The optimizing places routing instructions in clusters along a routing path within the reconfigurable fabric. The routing instructions are placed in unused cluster control instruction locations to enable spatial routing.

### RELATED APPLICATIONS

This application claims the benefit of U.S. provisional patent applications “Reconfigurable Fabric Configuration Using Spatial and Temporal Routing” Ser. No. 62/773,486, filed Nov. 30, 2018, “Machine Learning for Voice Calls Using a Neural Network on a Reconfigurable Fabric” Ser. No. 62/800,432, filed Feb. 2, 2019, “FIFO Filling Logic for Tensor Calculation” Ser. No. 62/802,307, filed Feb. 7, 2019, “Matrix Multiplication Engine Using Pipelining” Ser. No. 62/827,333, filed Apr. 1, 2019, “Dispatch Engine with Queuing and Scheduling” Ser. No. 62/850,059, filed May 20, 2019, “Artificial Intelligence Processing Using Reconfiguration and Tensors” Ser. No. 62/856,490, filed Jun. 3, 2019, “Dispatch Engine with Interrupt Processing” Ser. No. 62/857,925, filed Jun. 6, 2019, “Data Flow Graph Computation Using Barriers with Dispatch Engines” Ser. No. 62/874,022, filed Jul. 15, 2019, “Integer Multiplication Engine Using Pipelining” Ser. No. 62/882,175, filed Aug. 2, 2019, “Multidimensional Address Generation for Direct Memory Access” Ser. No. 62/887,713, filed Aug. 16, 2019, “Processor Cluster Dispatch Engine with Dynamic Scheduling” Ser. No. 62/887,722, filed Aug. 16, 2019, “Data Flow Graph Computation Using Barriers” Ser. No. 62/893,970, filed Aug. 30, 2019, “Data Flow Graph Computation with Barrier Counters” Ser. No. 62/894,002, filed Aug. 30, 2019, “Distributed Dispatch Engine for Use with Heterogeneous Accelerators” Ser. No. 62/898,114, filed Sep. 10, 2019, “Data Flow Processing Dispatch Graph Compilation” Ser. No. 62/898,770, filed Sep. 11, 2019, and “Processor Cluster Address Generation” Ser. No. 62/907,907, filed Sep. 30, 2019.

This application is also a continuation-in-part of “Reconfigurable Fabric Data Routing” Ser. No. 16/104,586, filed Aug. 17, 2018, which claims the benefit of U.S. provisional patent applications “Reconfigurable Fabric Data Routing” Ser. No. 62/547,769, filed Aug. 19, 2017, “Tensor Manipulation Within a Neural Network” Ser. No. 62/577,902, filed Oct. 27, 2017, “Tensor Radix Point Calculation in a Neural Network” Ser. No. 62/579,616, filed Oct. 31, 2017, “Pipelined Tensor Manipulation Within a Reconfigurable Fabric” Ser. No. 62/594,563, filed Dec. 5, 2017, “Tensor Manipulation Within a Reconfigurable Fabric Using Pointers” Ser. No. 62/594,582, filed Dec. 5, 2017, “Dynamic Reconfiguration With Partially Resident Agents” Ser. No. 62/611,588, filed Dec. 29, 2017, “Multithreaded Dataflow Processing Within a Reconfigurable Fabric” Ser. No. 62/611,600, filed Dec. 29, 2017, “Matrix Computation Within a Reconfigurable Processor Fabric” Ser. No. 62/636,309, filed Feb. 28, 2018, “Dynamic Reconfiguration Using Data Transfer Control” Ser. No. 62/637,614, filed Mar. 2, 2018, “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, and “Data Flow Graph Computation Using Exceptions” Ser. No. 62/694,984, filed Jul. 7, 2018.

Each of the foregoing applications is hereby incorporated by reference in its entirety.

### FIELD OF ART

This application relates generally to data manipulation and more particularly to reconfigurable fabric configuration using spatial and temporal routing.

### BACKGROUND

Data is widely collected from people and their electronic devices. Whether an individual is using her smartphone to peruse news headlines, or another person is using his tablet to order pet food, metadata about their usage is collected. Websites visited, products viewed, and buttons clicked are all collected, analyzed, and frequently monetized. The data is used to deliver content, products, or services that are predicted to be of interest to the user. Emerging processor architectures and software techniques enable the collection of ever increasing amounts of data. Researchers, businesspeople, and governments collect vast amounts of data that is gathered into datasets, typically referred to as “big data”, which can then be analyzed. The analysis of big data is nearly intractable using general purpose or traditional computational techniques and processors. The near-intractability occurs because the sizes of datasets far outstrip the capabilities of the processors and analysis techniques employed previously. The computational and processing requirements are further complicated by the access, capture, maintenance, storage, transmission, and visualization of data, among other tasks. These additional requirements quickly overwhelm the capacities of the traditional systems. The data essentially would be of little or no value to any stakeholders if there were no viable and scalable data analysis and handling techniques to meet the requirements and applications of the data. Innovative computing architectures, plus software techniques, algorithms, and heuristics, are demanded. Dataset owners or those who have access to the datasets are motivated for business and research purposes to analyze the data contained within. Data analysis purposes can include business analysis; disease or infection detection, tracking, and control; crime detection and prevention; meteorology; and complex science and engineering simulations, to name but a very few. Advanced data analysis techniques are finding applications such as predictive analytics which can show consumers what they want, even before the consumers know they do. Additional approaches include applying machine learning and deep learning techniques in support of the data analysis.

The advent of improved processors and learning techniques has expanded and greatly benefited machine learning and many other computer science disciplines. Machine learning supposes that a machine can “learn” about a unique dataset, without the machine having to be explicitly coded or programmed by a user to handle that dataset. Machine learning can be performed on a network such as a neural network. The neural network can process the big data in order for the neural network to learn. The greater the quantity of data that is processed, the better the machine learning outcome. The processors on which the machine learning techniques can be executed are designed to efficiently handle the flow of data. These processors, which are based on data flow architectures, process data when valid data becomes available. This allows for helpful simplifications and in some cases avoids a need for a global system clock.

Reconfigurable hardware is a highly flexible and advantageous computing architecture that is well suited to processing large data sets, performing complex computations, and executing other computationally resource-intensive applications. Reconfigurable computing integrates the key features of hardware and software techniques. A reconfigurable computing architecture can be “recoded” (reprogrammed). The recoding adapts or configures the high-performance hardware architecture, much like recoding software. A reconfigurable fabric hardware technique is directly applicable to reconfigurable computing. Reconfigurable fabrics may be arranged in configurations or topologies for the many applications that require high performance computing. Applications such as processing of big data, digital signal processing (DSP), machine learning based on neural networks, matrix or tensor computations, vector operations or Boolean manipulations, and so on, can be implemented within a reconfigurable fabric. The reconfigurable fabric operates particularly well when the data can include specific types of data, large quantities of unstructured data, sample data, and the like. The reconfigurable fabrics can be coded or scheduled to achieve these and other processing techniques, and to represent a variety of efficient computer architectures.

### SUMMARY

The processing of vast quantities of data such as unstructured data is widely applicable. The data, which is collected into large datasets or “big data”, is processed for applications in areas such as artificial intelligence, trend analysis, business analytics, machine learning (including deep learning), medical research, law enforcement, public safety, and so on. Traditional processors and processing techniques for data analysis fall far short of the voluminous data handling requirements. Data analysis systems designers and engineers have tried to meet the processing requirements by building or purchasing faster processors, designing custom integrated circuits (chips), implementing application specific integrated circuits (ASICs), programming field programmable gate arrays (FPGAs), etc. These approaches are based on computer and chip architectures, such as Von Neumann architectures, which are focused on how control of the chip operations (control flow view) is performed. Alternatively, the flow of data (data flow view) can be considered. In a data flow architecture, the execution of instructions, functions, subroutines, kernels, agents, apps, etc. is based on the presence or absence of valid data which is available to a processor. This latter approach, that of a data flow architecture, is far better suited to the tasks of handling the large amounts of unstructured data that is processed as part of the machine learning and deep learning applications. The data flow architecture obviates the need for centralized control of the processing since no system clocks or centralized control signals are required. A data flow architecture can be implemented using a reconfigurable fabric.

Reconfigurable fabric configuration based on spatial and temporal routing is used for data manipulation. A computer-implemented method for data manipulation is disclosed comprising: allocating a plurality of clusters within a reconfigurable fabric, wherein the plurality of clusters is configured to execute one or more functions; calculating a first spatial routing and a first temporal routing through the reconfigurable fabric; calculating a second spatial routing and a second temporal routing through the reconfigurable fabric; optimizing the first and second spatial routings and the first and second temporal routings; and executing the one or more functions, using the routings that were optimized. In embodiments, the first spatial routing enables a logical connection for data transfer between at least two clusters of the plurality of clusters. The first temporal routing enables a latency-aware data transfer between the at least two clusters. In further embodiments, the second spatial routing enables a logical connection for data transfer between at least two additional clusters of the plurality of clusters. The second temporal routing enables a latency-aware data transfer between the at least two additional clusters. In some embodiments, the optimizing places routing instructions in one or more clusters along a routing path within the reconfigurable fabric, where the routing instructions are placed in unused cluster control instruction locations within clusters of the reconfigurable fabric to enable spatial routing. In some embodiments, the unused cluster control instruction locations are contained in instruction RAM (iRAM) instantiations. Some embodiments comprise utilizing an additional register between two of the iRAM instantiations to enable temporal routing. In some embodiments, the additional register adds delay in routing instruction propagation within the reconfigurable fabric. And in some embodiments, the iRAM instantiations are included within L2 switches.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for reconfigurable fabric configuration using spatial and temporal routing.

FIG. 2 is a flow diagram for optimizing fabric porosity.

FIG. 3 shows a server allocating FIFOs and processing elements.

FIG. 4 illustrates an example block diagram for kernel mapping with porosity map.

FIG. 5A shows a block diagram of a reconfigurable fabric showing clusters and fabric input/output.

FIG. 5B shows an example reconfigurable fabric with kernel 1 and kernel 2 mounted and with input and output for kernel 1 via kernel 2.

FIG. 5C shows an example reconfigurable fabric with kernel 1, kernel 2, and kernel 3 mounted, and output from kernel 1 via kernel 3.

FIG. 6 is an example illustrating a porosity map.

FIG. 7 shows a reconfigurable fabric cluster topology with route-through communication.

FIG. 8 illustrates a cluster for coarse-grained reconfigurable processing.

FIG. 9 shows routing through L2 switches and additional registers.

FIG. 10 illustrates a block diagram of a circular buffer.

FIG. 11 shows a circular buffer and processing elements.

FIG. 12 illustrates a deep learning block diagram.

FIG. 13A shows spatial cluster routing.

FIG. 13B shows temporal cluster routing.

FIG. 14A illustrates machine partitioning.

FIG. 14B shows hierarchical machine groupings.

FIG. 15 is a system diagram for reconfigurable fabric configuration.

### DETAILED DESCRIPTION

Techniques for data manipulation within a reconfigurable computing environment are disclosed. Functions, algorithms, heuristics, apps, etc., can be used to process large datasets. The large amounts of data, or “big data”, overwhelm conventional, control-based computer hardware techniques such as Von Neumann techniques. The functions, algorithms, heuristics, and so on, instead can be described using data flow graphs, agents, functions, networks, and so on. The data flow graphs, agents, functions, networks, etc. can be decomposed or partitioned into smaller operations such as kernels. The kernels can be allocated to single processing elements, clusters of processing elements, a plurality of clusters of processing elements, co-processors, etc. The processing elements are included within a reconfigurable fabric. The reconfigurable fabric includes elements that can be configured as processing elements, switching elements, storage elements, and so on. The configuring of the elements within the reconfigurable fabric, and the operation of the configured elements, can be controlled by rotating circular buffers. The rotating circular buffers can be coded, programmed, or “scheduled” to control the elements of the reconfigurable array. The rotating circular buffers can be statically scheduled. The reconfigurable fabric further includes ports such as input ports, output ports, and input/output (bidirectional) ports, etc., which can be used to transfer data both into and out of the reconfigurable fabric.

In a reconfigurable fabric, mesh network, distributed network, or other suitable processing topology, the multiple processing elements (PEs) obtain data, process data, store data, transfer data to other processing elements, and so on. The processing that is performed can be based on kernels, agents, functions, etc., which include sets of instructions that are allocated to a single PE, a cluster of PEs, a plurality of clusters of PEs, etc. The clusters of PEs can be distributed across the reconfigurable fabric. In order for processing of the data to be performed effectively and efficiently, the data must be routed from input ports of the reconfigurable fabric, through the reconfigurable fabric, to the clusters of PEs that require the data. Further, data must be routed from outputs of the clusters of PEs, through the reconfigurable fabric, to output ports of the reconfigurable fabric. The data is required to arrive at the designated PEs at the correct time and in the proper order. The data passing is accomplished by reconfigurable fabric configuration using spatial and temporal routing.

Reconfigurable fabric operation includes data manipulation. A plurality of clusters within a reconfigurable fabric is allocated, where the plurality of clusters is configured to execute one or more functions. A first spatial routing and a first temporal routing through the reconfigurable fabric are calculated. The first spatial routing and the first temporal routing can be based on a porosity map, where the porosity map describes the “porosity” or available communication channels through allocated clusters within the reconfigurable fabric. A second spatial routing and a second temporal routing through the reconfigurable fabric are calculated. Further spatial and temporal routings, such as a third spatial routing and a third temporal routing, can also be calculated. The first and second spatial routings and the first and second temporal routings are optimized. Similarly, other spatial and temporal routings, such as the third spatial routing and the third temporal routing, can be optimized. The optimizing of the third spatial routing and the third temporal routing can be further optimized with the first and second spatial routings, and the first and second temporal routings. The one or more functions are executed, using routings that were optimized.

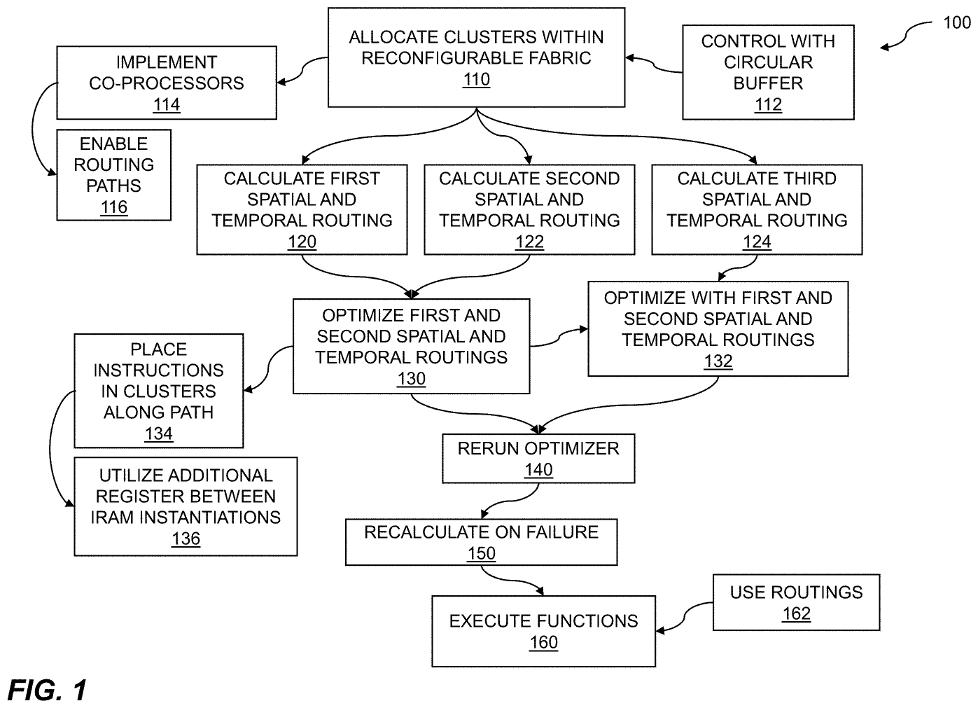

FIG. 1 is a flow diagram for reconfigurable fabric configuration using spatial and temporal routing. The reconfigurable fabric can be configured to perform various data manipulation operations. The data manipulation operations can include logical operations, mathematical operations, and so on. The flow 100 includes allocating a plurality of clusters within a reconfigurable fabric 110. Each cluster of the plurality of clusters comprising the reconfigurable fabric can include processing elements (PEs), switching elements (SEs), storage elements (STEs), and the like. The PEs can execute the kernels, agents, co-processors, or functions; the SEs can transfer data between or among PEs; the STEs can store data for processing, transfer, etc. The plurality of clusters can be configured to execute one or more functions, where the functions can include data manipulation operations as discussed throughout. The reconfigurable fabric further can include communication ports for data input/output and control. In embodiments, each cluster of the plurality of clusters that can form the reconfigurable fabric can be controlled by one or more circular buffers 112. The circular buffers can execute instructions that can control the pluralities of clusters. The circular buffers can be the same size or different sizes. The circular buffers can circulate continuously, can be put into sleep modes, and so on.

In embodiments, the one or more circular buffers are statically scheduled. Static scheduling can include repeating execution of the same code within the circular buffers until the circular buffers can be reprogrammed. Thus, static scheduling is different from dynamic scheduling, for which new code must be loaded into the circular buffers to continue the same task, such as in a standard von Neumann processor architecture. Static scheduling of circular buffers is also different from FPGA programming. In FPGA programming, the hardware is loaded with a certain functionality at program time, during which the FPGA is non-functional. Statically scheduled circular buffers allow a reconfigurable fabric to perform new functions and receive updates while the fabric is running, but not while the current circular buffer instructions are being executed. The reconfigurable fabric can be based on a variety of system architectures which can include one or more clocks, system clocks, and so on. The reconfigurable fabric can be self-clocked. In embodiments, the reconfigurable fabric is self-clocked on a hum basis. The clusters configured for functions within the self-clocked reconfigurable fabric can perform operations on data when the data is available for processing rather than relying on a centralized clocking scheme. In embodiments, the clusters implement co-processors within the reconfigurable fabric 114. The co-processors can be implemented within a single cluster or can span multiple clusters. The co-processors can operate individually or in tandem with other co-processors to perform the one or more functions. In embodiments, the co-processors enable routing paths through the reconfigurable fabric 116.

The functions that are implemented by the clusters within the reconfigurable fabric can be represented by graphs, networks, and so on. In embodiments, the one or more functions can be part of a data flow graph implemented in the reconfigurable fabric. The data flow graph includes nodes which perform operations, and arcs that indicate the flow of data between and among the nodes. The nodes of the data flow graph can be implemented using one or more kernels. The one or more kernels can include code for algorithms, functions, heuristics, processes, routines, and so on. In embodiments, the plurality of kernels can include islands of machine code scheduled onto machine cycles. The kernels can include software, code segments, applications, apps, schedules, etc. The operations of kernels can include linked operations within the reconfigurable fabric. Linked operations can be linked in terms of execution order such as first to execute, second to execute, parallel execution, etc.; in terms of data flow; and so on. The linked operations can be part of a meta-structure such as a graph. The linked operations can be part of the data flow graph implemented in the reconfigurable fabric. The data flow graph can comprise a network such as a neural network. In embodiments, the data flow graph implements machine learning, while in other embodiments, the data flow graph implements deep learning. Machine learning, deep learning, and so on, can utilize one or more neural networks. Various techniques can be used to implement the one or more neural networks; used for the machine learning, deep learning; etc. In embodiments, the one or more neural networks comprise a convolutional neural network (CNN). Convolutional neural networks can include feed-forward artificial neural networks. In other embodiments, the one or more neural networks comprise a recurrent neural network (RNN). Recurrent neural networks can include artificial neural networks in which one or more connections between or among nodes can form a directed graph along a given sequence.

The flow 100 includes calculating a first spatial routing and a first temporal routing 120 through the reconfigurable fabric. A spatial routing can include interconnection paths, communications channels, switching elements, and so on, which can be used for communicating between or among processing elements, clusters, co-processors, and the like. In embodiments, the first spatial routing can enable a logical connection for data transfer between at least two clusters of the plurality of clusters. The logical connection can include one or more of interconnects, channels, switching elements, etc. In embodiments, the first temporal routing can enable a latency-aware data transfer between the at least two clusters. The latency-aware data transfer can minimize latency by reducing a number of switching elements, length of interconnects, etc. The latency-aware data transfer can include preloading data so that the data arrives at a target cluster without causing the cluster to remain idle while waiting for needed data. The flow 100 includes calculating a second spatial routing and a second temporal routing 122 through the reconfigurable fabric. The second spatial routing can also include interconnections paths, communications channels, switching elements of the reconfigurable fabric, etc. In embodiments, the second spatial routing can enable a logical connection for data transfer between at least two additional clusters of the plurality of clusters. As with other temporal routings, in embodiments, the second temporal routing can enable a latency-aware data transfer between the at least two additional clusters. While calculating both first and second spatial routings and first and second temporal routings have been described, other numbers of spatial and temporal routings can be calculated. The flow 100 further includes calculating a third spatial routing and a third temporal routing 124 through the reconfigurable fabric. The third spatial routing can enable a logical connection for data transfer between at least two further additional clusters of the plurality of clusters. The third temporal routing can enable a latency-aware data transfer between at least two further additional clusters of the plurality of clusters.

Spatial routing can enable logical connection for data transfer between at least two clusters of the plurality of clusters within a reconfigurable fabric. A route specified for the spatial routing may not include any timing considerations for the transfer of information such as instructions or data. The spatial routing can include interconnects, communications channels, switching elements, and other “paths” through which data can be transferred. The transferring of the instructions or data may be delayed, thus introducing latency, as one or more spatial routes become unavailable for a period of time such as one or more tic cycles. A spatial route can become unavailable as the spatial route is used for data transfer between at least two other clusters of the plurality of clusters within the reconfigurable fabric. When the spatial route is unavailable, data can be held in a register such as a register within an L2 switch. When the spatial route again becomes available, then the data transfer can resume.

Discussed below, spatial routings or temporal routings can be optimized. Instructions or data can be routed through the reconfigurable fabric using a spatial routing. A spatial routing may be shared by two or more clusters, and shared by two or more additional clusters. The sharing, which can occur between the clusters or the additional clusters but not during the same tic cycle, causes the spatial routing to become unavailable for one or more tic cycles. Due to the sharing, the spatial routing may be available to two or more clusters for an amount of time, made available to two or more additional clusters for an amount of time, then made available again to the two or more initial clusters. The availability of a spatial routing can change based on a tic cycle. When instructions are being transferred along a spatial routing, the instructions can be held for one or more tic cycles in registers. The registers can include registers of one or more L2 switches.

The flow 100 includes optimizing the first and second spatial routings and the first and second temporal routings 130. The optimizing can be with respect to an individual routing such as the first routing or the second routing, where the optimizing can include minimizing the length of an individual spatial routing, minimizing the latency of a temporal routing, and so on. The optimizing can be with respect to two or more routings such as the first routing and the second routing, where the optimizing can ensure that two or more logical connections can transfer data with minimal or no contention. The optimizing can include routings other than the first and second spatial routings and the first and second temporal routings. In the flow 100, the third spatial routing and the third temporal routing are further optimized with the first and second spatial routings and the first and second temporal routings 132. Further spatial and temporal routings may also be optimized. The optimizing can be based on reconfigurable fabric porosity, as will be discussed shortly. Information pertaining to reconfigurable fabric porosity can be collected into a porosity map. The porosity map can include data relating to one or more clusters such as percent utilization, routing density, routing diversity, utilization schedule, and so on. In embodiments, the calculating a first spatial routing and a first temporal routing and the calculating a second spatial routing and a second temporal routing can be based on a porosity map.

In the flow 100, the optimizing places routing instructions in one or more clusters along a routing path 134 within the reconfigurable fabric. The routing instructions can include instructions for one or more rotating circular buffers, where the rotating circular buffers can control elements of the reconfigurable fabric. The routing instructions can be statically scheduled. In embodiments, the routing instructions can be placed in unused cluster control instruction locations within clusters of the reconfigurable fabric to enable spatial routing. The unused cluster control instruction locations can be included in one or more circular buffers or in other storage elements. In the flow 100, the unused cluster control instruction locations are contained in instruction RAM (iRAM) instantiations 136. The instruction RAM or iRAM instantiations may be able to store a portion of or all of the routing instructions. Additional storage may be required for the routing instructions. The additional storage can introduce delay elements to enable data transfer. Further embodiments include utilizing an additional register between two of the iRAM instantiations to enable temporal routing. The additional delay in the temporal routing can ensure that data arrives at a cluster at the time the data is required by the cluster. Instructions can also be routed. In embodiments, the additional register adds delay in routing instruction propagation within the reconfigurable fabric. The iRAM instantiations can include one or more elements within the reconfigurable fabric. In embodiments, the iRAM instantiations are included within L2 switches.

Further optimizing of spatial and/or temporal routings can be performed by repeating optimizations, by using iterative optimization techniques, and so on. In the flow 100, the first, second, and third spatial routings and the first, second, and third temporal routings are further optimized by rerunning the optimizing 140. Various optimization techniques can be used which include techniques based on first order techniques such as gradient descent; iterative techniques such as sequential quadratic programming; heuristics such as genetic algorithms; and the like. The optimizing that can be based on techniques includes simulated annealing. The optimizing may not always be successful. The flow 100 further includes recalculating new first and second spatial routings and new first and second temporal routings based on a failure of the optimizing 150. The recalculating can also include recalculating a new third spatial routing, a new third temporal routing, or further spatial and temporal routings. The flow 100 includes executing the one or more functions 160. The one or more functions that can be executed can include logical operations, arithmetical operations, matrix operations, tensor operations, and the like. The executing the one or more functions includes using routings that were optimized 162.

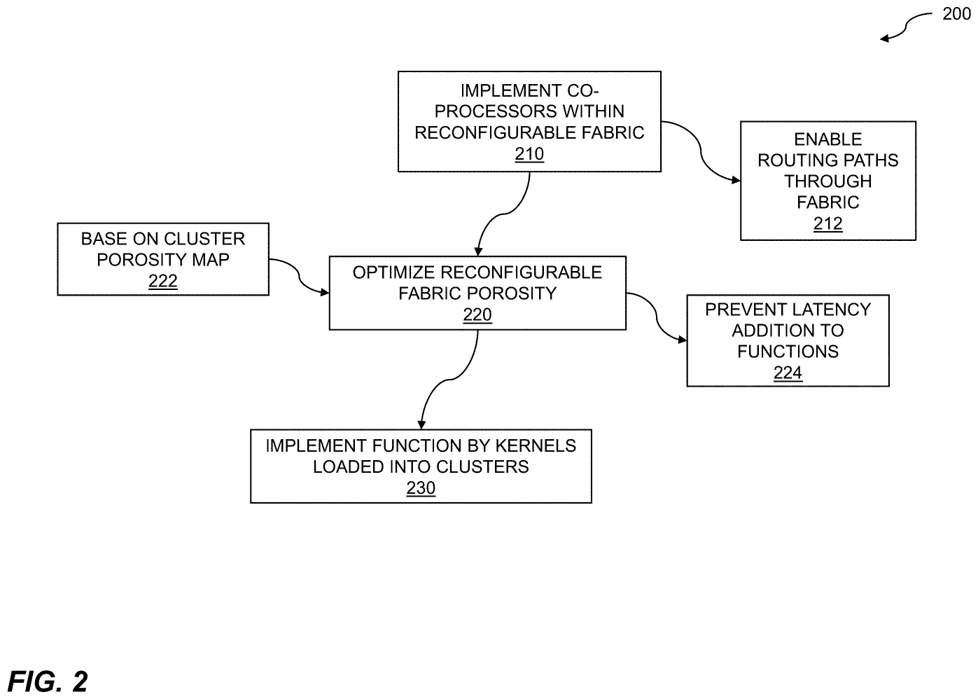

FIG. 2 is a flow diagram for optimizing fabric porosity. Discussed throughout, routings, whether spatial routings or temporal routings, can be optimized. The optimization can be performed to reduce the length of a path for transferring data between or among allocated clusters, minimizing data transfer latency, and so on. The optimizing further can be based on the routing available through functions that have been allocated previously to clusters within a reconfigurable fabric. The available routing or “porosity” of the allocated clusters can be collected into a porosity map. In embodiments, the optimizing can be a function of reconfigurable fabric porosity. The porosity can be based on the locations of the allocated clusters within the reconfigurable fabric, adjacencies of allocated clusters to inputs/outputs or to each other, and so on. The data transfer, which includes evaluating data input needs and data output needs, can be used for reconfigurable fabric configuration using spatial and temporal routing. A plurality of clusters is allocated within a reconfigurable fabric, where the clusters are configured to execute one or more functions. First and second spatial routings, and first and second temporal routings, are calculated through the reconfigurable fabric. The first and second spatial routings and the first and second temporal routings are optimized, and the one or more functions are executed, using routings that were optimized.

In the flow 200, the clusters implement co-processors within the reconfigurable fabric 210. Co-processors can include one or more of processing elements, storage elements, switching elements, and so on. In embodiments, a co-processor can include one or more clusters within a reconfigurable fabric. A co-processor can implement a function, an agent, a data flow graph, a Petri Net, a network, etc. A co-processor can perform logical operations, arithmetic operations, complex operations, etc. In embodiments, the co-processors can enable routing paths through the reconfigurable fabric 212. The routing paths can be operated by a co-processor that contains a routing path. The co-processors may be controlled by one or more circular buffers, where the one or more circular buffers can be statically scheduled.

In the flow 200, optimizing can be a function of reconfigurable fabric porosity 220. The porosity of the reconfigurable fabric can be based on an amount of interconnects, a number of communication channels, a number of available switching elements, and so on. The porosity can be included in a map, such as a porosity map, of the available interconnects, channels, or switching elements. In embodiments, the optimizing can be based on a cluster porosity map 222. The optimizing can include determining a shortest communication path for data transfer, identifying a data transfer path with the least amount of latency, and the like. In embodiments, the optimizing can prevent latency addition to the one or more functions 224. Preventing latency addition can be based on reducing path length, such as a number of registers along a data transfer path; preloading data to propagate along a data transfer path; etc. In embodiments, the optimizing can include evaluating data input or output needs of a given kernel. The data input and data output needs of the kernel can include the type of data, the amount of data, a time at which the data can be sent or collected, a time at which the output data is required elsewhere by a further kernel, and so on. In the flow 200, the one or more functions are implemented by kernels loaded into the plurality of clusters 230. In embodiments, functions can be implemented by kernels, agents, processes, and the like. The kernels can be based on programs, codes, algorithms, heuristics, and so on, that can be loaded into the clusters within the reconfigurable fabric. The plurality of clusters of the reconfigurable fabric that implement the kernels, for example, can be controlled by the one or more circular buffers.

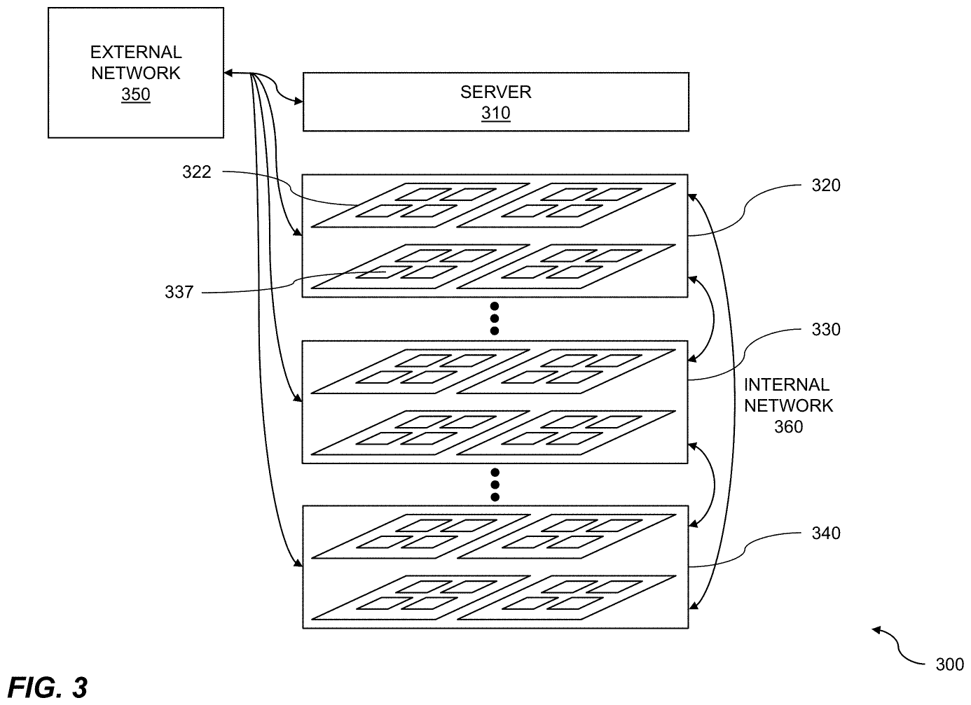

FIG. 3 shows a server allocating FIFOs and processing elements. A data flow graph, Petri Net, network, and so on, can be allocated to first-in-first-out registers (FIFOs) and to elements. The elements can include processing elements, storage elements, switching elements, and so on. First-in-first-out (FIFO) techniques can be used to support reconfigurable fabric configuration using spatial and temporal routing. The FIFOs and the processing elements can be elements within a reconfigurable fabric. The processing elements can be grouped into clusters, where the clusters can be configured to execute one or more functions. The processing elements can be configured to implement kernels, agents, a data flow graph, a network, and so on, by programming, coding, or “scheduling” rotating circular buffers. The circular buffers can be statically scheduled. A plurality of clusters within a reconfigurable fabric is allocated, where the plurality of clusters is configured to execute one or more functions. A first spatial routing and a first temporal routing through the reconfigurable fabric are calculated. A second spatial routing and a second temporal routing through the reconfigurable fabric are calculated. The first and second spatial routings and the first and second temporal routings are optimized, and the one or more functions are executed, using routings that were optimized.

The system 300 can allocate one or more first-in-first-out (FIFO) and processing elements (PEs) for reconfigurable fabric data routing. The system can include a server 310 allocating FIFOs and processing elements. In embodiments, system 300 includes one or more boxes, indicated by callouts 320, 330, and 340. Each box may have one or more boards, indicated generally as 322. Each board comprises one or more chips, indicated generally as 337. Each chip may include one or more processing elements, where at least some of the processing elements may execute a process agent, a kernel, or the like. An internal network 360 allows for communication between and among the boxes such that processing elements on one box can provide and/or receive results from processing elements on another box.

The server 310 may be a computer executing programs on one or more processors based on instructions contained in a non-transitory computer readable medium. The server 310 may perform reconfiguring of a mesh networked computer system comprising a plurality of processing elements with a FIFO between one or more pairs of processing elements. In some embodiments, each pair of processing elements has a dedicated FIFO configured to pass data between the processing elements of the pair. The server 310 may receive instructions and/or input data from external network 350. The external network may provide information that includes, but is not limited to, hardware description language instructions (e.g. Verilog, VHDL, or the like), flow graphs, source code, or information in another suitable format.

The server 310 may collect performance statistics on the operation of the collection of processing elements. The performance statistics can include number of fork operations, join operations, average sleep time of a processing element, and/or a histogram of the sleep time of each processing element. Any outlier processing elements that sleep for a time period longer than a predetermined threshold can be identified. In embodiments, the server can resize FIFOs or create new FIFOs to reduce the sleep time of a processing element that exceeds the predetermined threshold. Sleep time is essentially time when a processing element is not producing meaningful results, so it is generally desirable to minimize the amount of time a processing element spends in a sleep mode. In some embodiments, the server 310 may serve as an allocation manager to process requests for adding or freeing FIFOs, and/or changing the size of existing FIFOs in order to optimize operation of the processing elements.

In some embodiments, the server may receive optimization settings from the external network 350. The optimization settings may include a setting to optimize for speed, optimize for memory usage, or balance between speed and memory usage. Additionally, optimization settings may include constraints on the topology, such as a maximum number of paths that may enter or exit a processing element, maximum data block size, and other settings. Thus, the server 310 can perform a reconfiguration based on user-specified parameters via external network 350.

Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include calculation input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PEs). The processing elements can include a processor, a data memory, an instruction memory, communications capabilities, and so on. Multiple PEs can be grouped, where the groups can include pairs, quads, octets, etc. The PEs arranged in arrangements such as quads can be coupled to arithmetic units, where the arithmetic units can be coupled to or included in data processing units (DPUs). The DPUs can be shared between and among quads. The DPUs can provide arithmetic techniques to the PEs, communications between quads, and so on.

The data flow processors, including data flow processors arranged in quads, can be loaded with kernels. The kernels can be a portion of a data flow graph. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value minus one plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0, then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. A configuration mode can be entered. Various techniques, including direct memory access (DMA) can be used to load instructions from the kernel into instruction memories of the PEs. The clusters that were preprogrammed to enter configuration mode can be preprogrammed to exit configuration mode. When configuration mode has been exited, execution of the one or more kernels loaded onto the clusters can commence. In embodiments, clusters can be reprogrammed, and during the reprogramming, switch instructions used for routing are not disturbed so that routing continues through a cluster.

Data flow processes that can be executed by data flow processor can be managed by a software stack. A software stack can include a set of subsystems, including software subsystems, which may be needed to create a software platform. A complete software platform can include a set of software subsystems required to support one or more applications. A software stack can include both offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™ CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so one. The agent source code that can be operated on by the software development kit can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit can include a variety of tools which can be used to support a deep learning technique or other technique which requires processing of large amounts of data such as unstructured data. The SDK can support multiple machine learning techniques such as machine learning techniques based on GEMM™, sigmoid, and so on. The SDK can include a low-level virtual machine (LLVM) which can serve as a front end to the SDK. The SDK can include a simulator. The SDK can include a Boolean satisfiability solver (SAT solver). The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a flow graph.

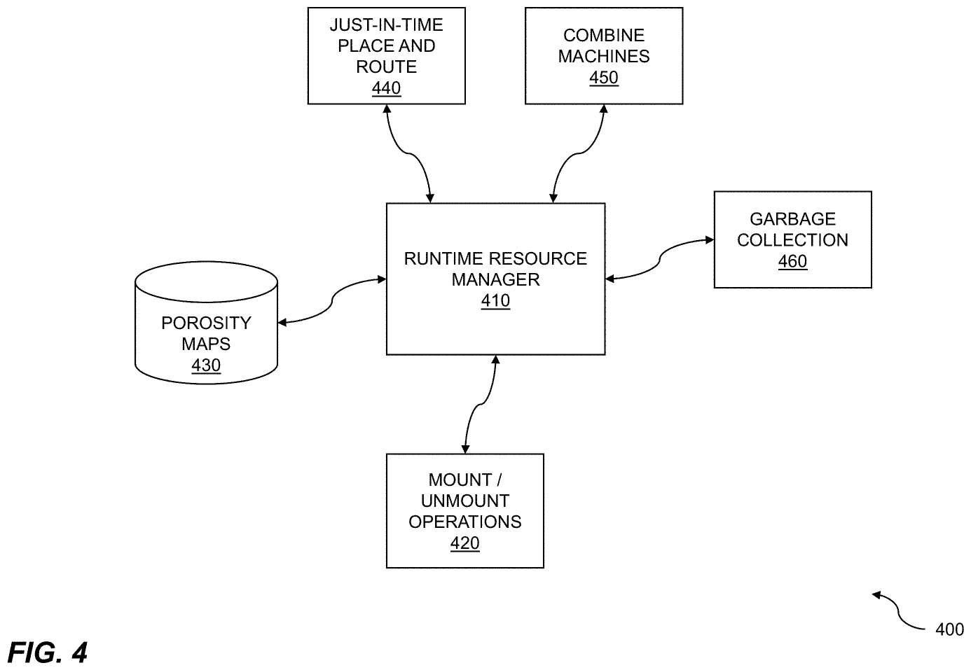

FIG. 4 illustrates an example block diagram for kernel mapping with a porosity map. A porosity map can be based on communications channels, interconnection paths, switching elements, and so on, that can be used for enabling data transfer between two or more kernels, agents, nodes of a graph such as a data flow graph, etc. A porosity map can be used for mapping one or more kernels to clusters of elements of a reconfigurable fabric, where the kernel mapping can be used for reconfigurable fabric configuration using spatial and temporal routing. A plurality of clusters within a reconfigurable fabric is allocated, where the plurality of clusters is configured to execute one or more functions. A first spatial routing and a first temporal routing through the reconfigurable fabric are calculated. A second spatial routing and a second temporal routing through the reconfigurable fabric are calculated. The first and second spatial routings and the first and second temporal routings are optimized, and the one or more functions are executed, using routings that were optimized.

A block diagram 400 is shown for kernel mapping with a porosity map. A porosity map through a set of clusters can be calculated based on available routing through the clusters. Kernel mapping techniques can include a runtime resource manager 410. The runtime resource manager can identify one or more kernels to be mounted in a set of clusters, determine clusters that are available for mounting kernels, requisition reconfigurable fabric inputs and outputs for data sending and data receiving, and so on. The runtime resource manager can call for mount and unmount operations 420. The mount and unmount operations can include mounting one or more kernels into clusters of the reconfigurable fabric, unmounting one or more kernels from clusters of the reconfigurable fabric, etc. The techniques used for mounting the kernels can be based on online placement and routing algorithms. The unmount techniques can remove paths through kernels, where the paths are based on porosity maps. The runtime resource manager can access one or more porosity maps 430. The one or more porosity maps, which can include the porosity maps through one or more clusters, can be calculated based on determining available routing through the clusters, can be uploaded by a user, can be downloaded over a computer network, etc. The runtime resource manager can request just-in-time place and route 440 techniques. The place and route techniques can include mounting kernels into allocated clusters, calculating porosity maps through mounted clusters, and so on. The routing can be based on a variety of placement and routing techniques, heuristics, and algorithms including an A* algorithm, Dijkstra's algorithm, etc. The runtime resource manager can combine machines 450. Combining machines can be used for mounting large kernels, where the kernels may be larger than the available clusters to which the kernel might be allocated. The kernels can be partitioned into sub-kernels, where the sub-kernels may be small enough to mount onto available clusters. The results from the sub-kernels can be combined using one or more combining machines. The runtime resource manager can request periodic garbage collection 460. Garbage collection can be used for memory management to reclaim freed up memory. Garbage collection can be used to remove unused porosity maps, routing information, determined routes, mount tables, and so on.

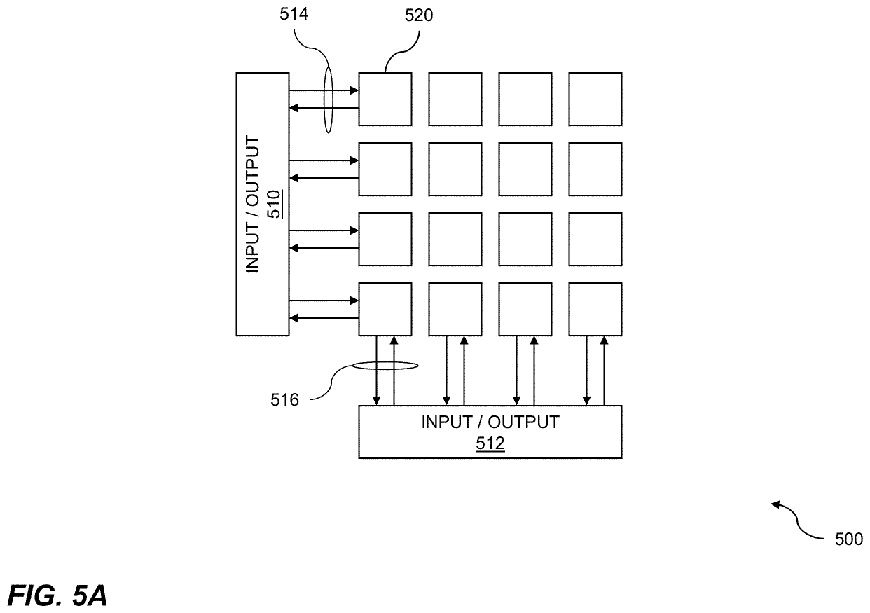

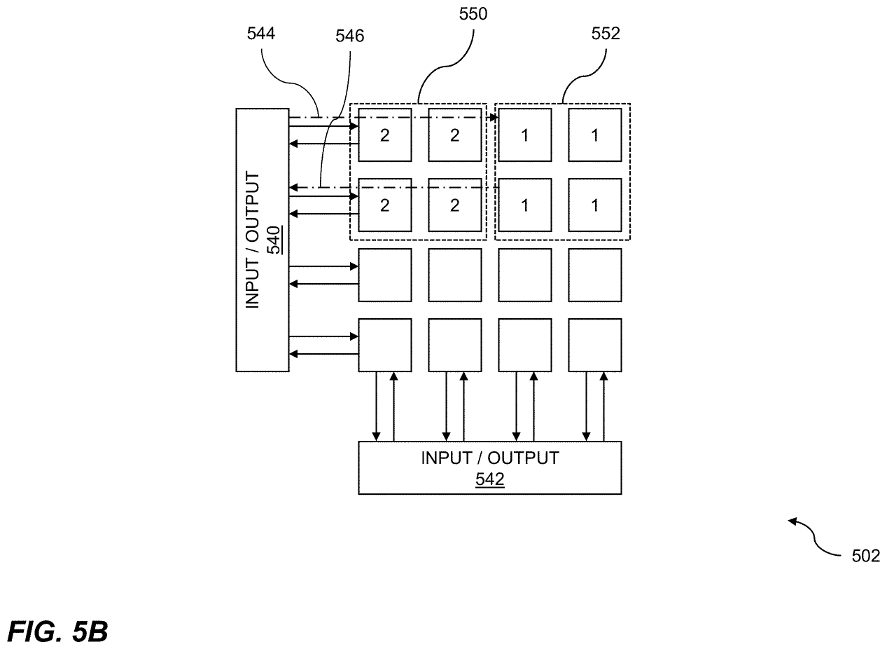

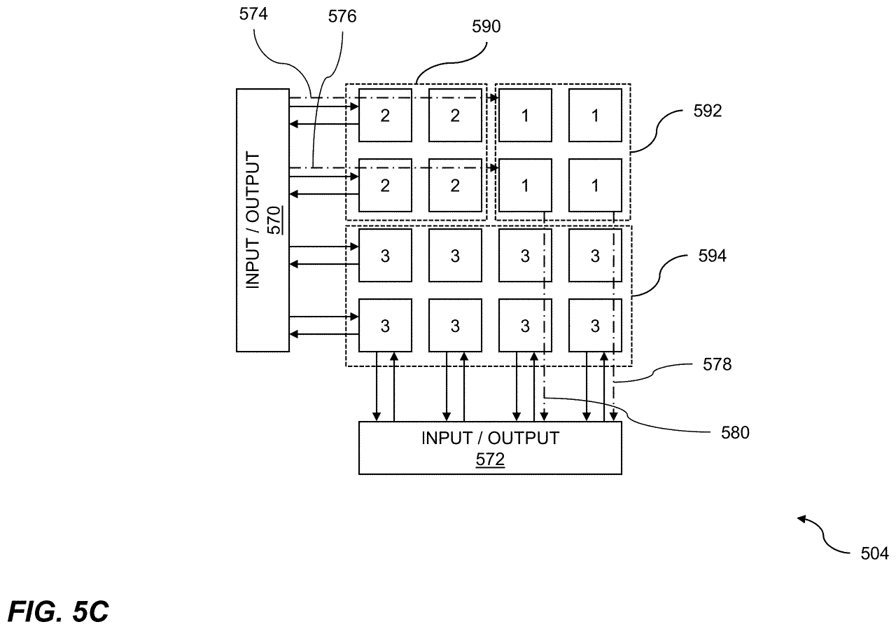

FIG. 5A depicts a block diagram of a reconfigurable fabric showing clusters and fabric input/output. Clusters can be allocated to kernels, nodes, agents, etc., and inputs/outputs can be designated for reconfigurable fabric configuration using spatial and temporal routing. Clusters are allocated within a reconfigurable fabric, where the clusters are configured to execute one or more functions such as logical functions, arithmetic functions, etc. First and second spatial routings are calculated, as are first and second temporal routings, where the routings are distributed through the reconfigurable fabric. The first and second spatial routings and the first and second temporal routings are optimized, where the optimizing places routing instructions in clusters along a routing path within the reconfigurable fabric. The functions are executed using routings that were optimized. Spatial routing can enable a logical connection for data transfer between at least two clusters of the plurality of clusters, and temporal routing can enable a latency-aware data transfer between the at least two clusters.

An example reconfigurable fabric 500 includes clusters and communications ports. The clusters can include elements, where the elements can be configured to perform various tasks within the reconfigurable fabric. In embodiments, the elements such as a processing element (PE), a switching element (SE), storage element (STE), and so on can be configured to perform tasks. The configuring of the elements of the reconfigurable fabric can include scheduling one or more circular buffers, where the circular buffers can be scheduled statically. The schedules within the circular buffers configure and control the various elements within the reconfigurable fabric. The schedule of a circular buffer, which can include code, instructions, algorithms, heuristics, and so on, can further include a kernel, an agent, and the like. The reconfigurable fabric can include input/output ports 510 for east-west communication within the reconfigurable fabric. The reconfigurable fabric can include input/output ports 512 for north-south communication within the reconfigurable fabric. The input/output ports 510 and input/output ports 512 can include input ports, output ports, in/out (bidirectional) ports, and so on. The input/output ports 510 can support east-west communications 514 with one or more clusters such as cluster 520. Similarly, input/output ports 512 can support north-south communications 516 with one or more clusters.

FIG. 5B shows an example reconfigurable fabric with kernel 1 and kernel 2 mounted and with input and output for kernel 1 via kernel 2. The kernels, kernel 1 and kernel 2, can be mounted in a reconfigurable fabric and input/output routes or paths can be determined. The kernel mounting and path routing include reconfigurable fabric data routing. A plurality of kernels is allocated across a reconfigurable fabric which includes a plurality of clusters, where the plurality of kernels includes at least a first kernel and a second kernel. The clusters can include processing elements, switching elements, storage elements, communications paths, and so on. The first kernel is mounted in a first set of clusters within the plurality of clusters, and a second kernel is mounted in a second set of clusters within the plurality of clusters. Available routing through the second set of clusters is determined. A porosity map through the second set of clusters is calculated based on the available routing through the second set of clusters. Data is sent through the second set of clusters to the first set of clusters based on the porosity map. The available routing through the second set of clusters can change during execution of the second kernel.

A reconfigurable fabric 502 is shown which includes input/output ports 540 and additional input/output ports 542. Kernels, including software kernels, can be mounted in clusters of the reconfigurable fabric. In the example, kernel 1 is mounted in a first allocation of clusters 552, and kernel 2 is mounted in a second allocation of clusters 550. Since kernel 1 may not have direct communication with input and output ports such as input/output ports 540, routes through kernel 2 for inputs and routes through kernel 2 for outputs are determined. A porosity map through the second set of clusters 550 can be calculated based on the available routing through the second set of clusters. An example input route 544 and an example output route 546 are shown. In embodiments, both of routes 544 and 546 can be input routes, output routes, in/out (bidirectional) routes, and so on. In embodiments, the available routing through the second set of clusters can change during execution of the second kernel. If the route through the second set of clusters assigned to the second kernel changes, then new routing can be determined, and a new porosity chart can be calculated.

FIG. 5C shows an example reconfigurable fabric with kernel 1, kernel 2, and kernel 3 mounted. An output from kernel 1 is routed via kernel 3. A third kernel can be mounted, and output routes through the third kernel can be determined for reconfigurable fabric data routing. A reconfigurable fabric cluster topology with route-through communication can be used for reconfigurable fabric data routing. Software kernels are allocated across a reconfigurable fabric that includes multiple clusters, where software kernels include at least a first kernel and a second kernel. The first kernel is mounted in a first set of clusters within the multiple clusters, and the second kernel is mounted in a second set of clusters within the multiple clusters. Available routing through the second set of clusters is determined. A porosity map through the second set of clusters is calculated based on the available routing through the second set of clusters. The porosity map can indicate paths along which data can route through the second set of clusters. Data is sent through the second set of clusters to the first set of clusters based on the porosity map.

A reconfigurable fabric 504 is shown which includes clusters, input/output ports 570, and additional input/output ports 572. One or more kernels can be assigned pluralities of clusters, and the kernels can be mounted in the allocated pluralities of clusters. Kernel 1 can be mounted in cluster 1 592, kernel 2 can be mounted in cluster 2 590, and kernel 3 can be mounted in cluster 3 594, and so on. Kernel 1 may not have direct communication with input ports, output ports, or input/output ports such as input/output ports 570 and input/output ports 572. For this example, kernel 1 can receive inputs through kernel 2 from input/output ports 570. Kernel 1 can send outputs through kernel 3 to input/output ports 572. As with the other examples, available routing through allocations of clusters must be determined for inputs to kernel 1 and for outputs from kernel 1. One or more porosity maps through the “blocking” or intermediate clusters are calculated based on the available routing through the clusters. Example input routes 574 and 576 are shown which route input data from input/output ports 570 through the cluster allocated to kernel 2 to kernel 1. Example output routes 578 and 580 are shown which route output data from kernel 1 through the cluster allocated to kernel 3 to input/output ports 572. In embodiments, the available routing through the second set of clusters can change during execution of the second kernel. In other embodiments, the available routing through the third set of clusters changes during execution of the third kernel. When the available routing changes, then one or more porosity maps can be calculated based on the available routing. New routes based on the porosity map can be used for routing input data, routing output data, and so on.

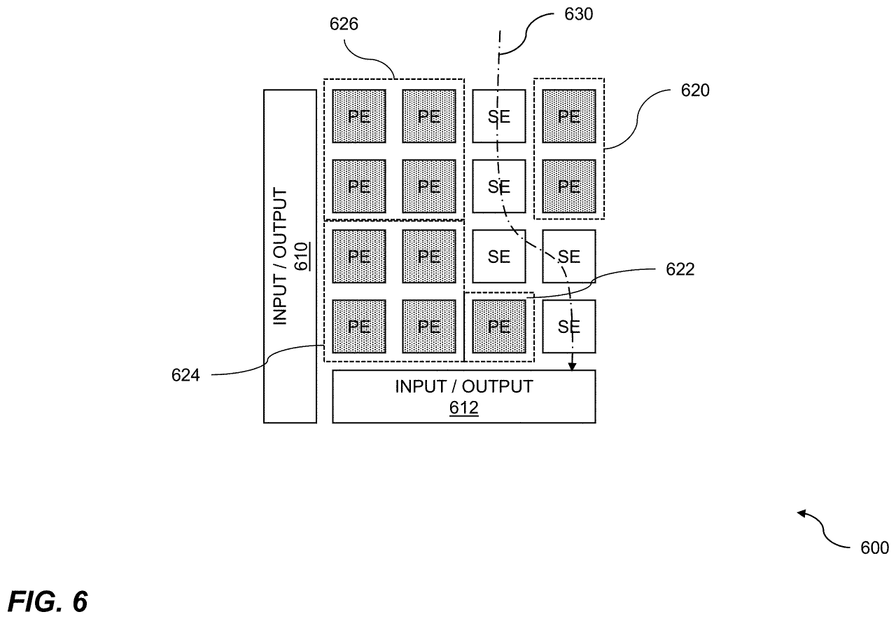

FIG. 6 is an example illustrating a porosity map. A porosity map can be calculated for reconfigurable fabric configuration using spatial and temporal routing. A plurality of clusters is allocated within a reconfigurable fabric, where the plurality of clusters is configured to execute one or more functions. A first spatial routing and a first temporal routing through the reconfigurable fabric are calculated. A second spatial routing and a second temporal routing through the reconfigurable fabric are calculated. The first and second spatial routings and the first and second temporal routings are optimized, and the one or more functions are executed, using routings that were optimized. The spatial routing enables a logical connection for data transfer between at least two clusters, and the temporal routing enables a latency-aware data transfer between the at least two clusters.

An example for calculating a porosity map 600 is shown. A reconfigurable fabric can include one or more pluralities of clusters, where the clusters include reconfigurable elements. The reconfigurable elements can be configured to perform various functions, algorithms, or heuristics; to support various processing or analysis tasks; and so on. Within a reconfigurable fabric, reconfigurable elements can be configured as processing elements (PEs), switching elements (SEs), storage elements (STEs), and so on. Communications to and from the reconfigurable fabric can be supported by ports, where the ports can include input ports, output ports, input/output (multidirectional) ports, and so on. East-west input/output ports 610, and north-south input/output ports 612 are shown. Other input ports, output ports, input/output ports, and so on can be coupled to the reconfigurable fabric. In example 600, four kernels have been allocated to clusters. A first kernel is allocated to a first cluster 620, a second kernel is allocated to a second cluster 622, a third kernel is allocated to a third cluster 624, and a fourth kernel is allocated to a fourth cluster 626. Other numbers of kernels can be allocated to other numbers of clusters. In the present example, four kernels are allocated to the four clusters 620, 622, 624, and 626; other clusters of elements remain unallocated. In embodiments, available routing through the unallocated clusters is determined. The available routing can include clusters that support nearest neighbor communication, clusters that support non-nearest neighbor communications, and so on. In embodiments, a porosity map can be calculated based on the available routing through the clusters. The clusters can be configured as switching elements (SEs) to form a “route through” 630. With available routing determined, data can be sent through the clusters based on the porosity map. Since the available routing through the clusters can change during execution of a given kernel, the porosity map can change. Updated routes can be determined, and data can be sent using the updated routes.

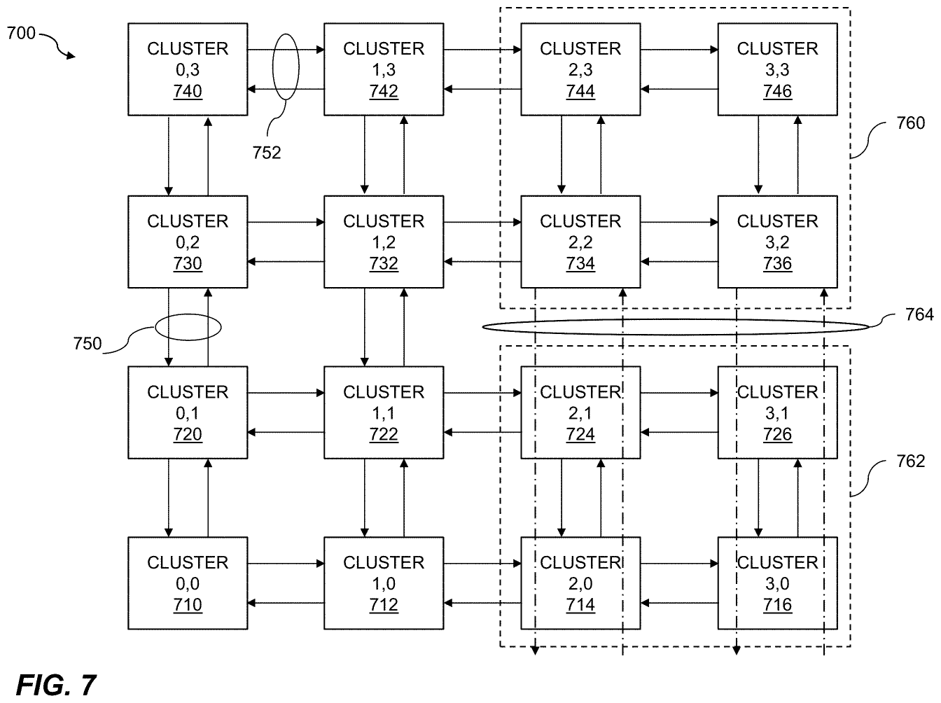

FIG. 7 shows a reconfigurable fabric cluster topology with route-through communication. A reconfigurable fabric cluster topology with route-through communication can be used for reconfigurable fabric configuration using spatial and temporal routing. The reconfigurable fabric cluster can be programmed, set, scheduled, or otherwise configured to support communications between or among kernels, agents, clusters, nodes, and so on. A plurality of clusters within a reconfigurable fabric is scheduled, where the plurality of clusters is configured to execute one or more functions. A first spatial routing and a first temporal routing through the reconfigurable fabric are calculated. A second spatial routing and a second temporal routing through the reconfigurable fabric are calculated. The first and second spatial routings and the first and second temporal routings are optimized. The one or more functions are executed using routings that were optimized. The spatial routing enables a logical connection for data transfer between at least two clusters of the plurality of clusters, and the temporal routing enables a latency-aware data transfer between the at least two clusters. The optimizing places routing instructions in one or more clusters along a routing path within the reconfigurable fabric.

As noted throughout, data can be sent along paths or routes that may exist through a plurality of clusters within a reconfigurable fabric. The aggregated paths, or porosity map, can be based on the available routing, where the available routing can be dependent on various factors. Embodiments include evaluating data input needs for the first kernel. The data input needs of the first kernel can include a type of data such as fixed-point data, matrices, tensors, arrays, etc. The data input needs can also include an amount of data, the source of the data, the location of the data (e.g. within a reconfigurable fabric or beyond the reconfigurable fabric), and the like. In embodiments, the sending data through the second set of clusters can based on data input needs for the first kernel. The sending of the data to a kernel can be controlled. Embodiments include controlling the available routing with instructions in circular buffers within the second set of clusters. The routing through a cluster such as the cluster mounted with the second kernel, can be dependent upon instructions, code, schedules, etc., of the second kernel. In embodiments, the available routing through the second set of clusters is a function of operations being performed by the second kernel. The routing through the second set of clusters can be dynamic. In embodiments, the available routing through the second set of clusters changes during execution of the second kernel.

A fabric of clusters 700 can include a cluster of processing elements (PEs) comprising a reconfigurable fabric. The reconfigurable fabric can include a plurality of interconnected clusters. In the example figure, a cluster 730 has a cluster 740 to its north, a cluster 732 to its east and a cluster 720 to its south. The cluster 730 exchanges data 750 with the southerly cluster 720 by using a south output connected to a north input of the cluster 720. Similarly, a south input of the cluster 730 is connected to a north output of the cluster 720. The cluster 740 exchanges data 752 with the cluster 742 oriented to the first cluster's east by using an east output connected to a west input of the second cluster 742. Similarly, an east input of cluster 740 is connected to a west output of cluster 742. In embodiments, the switching fabric is implemented with a parallel bus, such as a 32-bit bus. Other bus widths are possible, including, but not limited to, 16-bit, 64-bit, and 128-bit buses. Therefore, the configurable connections can provide for routing of a plurality of signals in parallel. In embodiments, the plurality of signals comprises four bytes. Communication through the configurable connections can be based on data being valid.

The fabric of clusters shown in FIG. 7 is a two-dimensional (2D) fabric, illustrating a mesh interconnection network where the clusters are placed in a two-dimensional grid. Each cluster is connected to its immediate neighbors as described in the case of the previously mentioned clusters as well as other clusters 710, 712, 714, 716, 722, 724, 726, 732, 734, 736, 744, and 746. Hence, in embodiments, the switching fabric is used in mesh computing. Other embodiments have a fabric of more than two dimensions. The configurable connections can provide three-dimensional (3D) routing. A three-dimensional (3D) embodiment can have additional cluster interconnectivity. In one embodiment, the 3D fabric is formed by layering multiple 2D mesh interconnect fabrics. The three-dimensional routing can include accessing a stacked chip. The stacked chip can be a 3D-integrated circuit where multiple die are stacked and interconnected with through-silicon vias (TSVs). In the case of three-dimensional routing, each cluster can have additional input and output ports. For example, in addition to the north, south, east, and west I/O ports, sets of up and down I/O ports can be present in each cluster to allow connectivity to clusters situated above and below a certain cluster. In embodiments, the configurable connections comprise a switching fabric that is attached to a plurality of processing elements. The configurable connections can route through one or more of silicon vias, two-dimensional connections, three-dimensional connections, or greater than three-dimensional connections.

For example, a setup such as a hypercube can allow for greater than three-dimensional interconnectivity. With n-dimensional hypercubes, the interconnection topology can comprise a plurality of clusters and a plurality of links, with “n” being an integer greater than or equal to three. Each cluster has a degree “n,” meaning that it is connected with links to “n” other clusters. The configurable connections can enable the bypassing of neighboring logical elements. In embodiments, some or all of the clusters in the fabric have a direct connection to a non-adjacent (non-neighboring) cluster. In embodiments, some or all of the clusters in the fabric have a direct connection to non-neighboring clusters using settable routes through neighboring clusters. The settable routes can include “route-throughs”. Within the fabric, each cluster of the plurality of clusters can have its own circular buffer. Therefore, the example fabric of clusters 700 includes a plurality of circular buffers. The plurality of circular buffers can have differing lengths. For example, the cluster 730 can have a circular buffer of length X, while the cluster 732 can have a circular buffer with a length of X+Y. In such a configuration, the cluster 730 sleeps after execution of the X−1 stage until the cluster 732 executes the X+Y−1 stage, at which point the plurality of circular buffers having differing lengths can resynchronize with the zeroth pipeline stage for each of the plurality of circular buffers. In an example where X=6 and Y=2, after the execution of a fifth stage, the cluster 730 sleeps until the cluster 732 executes the seventh stage, at which point both pipelines resynchronize and start executing the same stage together. The clusters (710-746) can be configured to function together to process data and produce a result. The result can be stored in one of the storage elements of a cluster. In some embodiments, the result is stored across multiple clusters. In embodiments, the switching fabric includes fan-in and fan-out connections. In embodiments, the storage elements store data while the configurable connections are busy with other data.

A first kernel, such as a software kernel, can be allocated to a first plurality of clusters 760. While a plurality of four clusters, clusters 734, 736, 744, and 746, is shown, other numbers of clusters can be included in a plurality of clusters. A second kernel can be allocated to a second plurality of clusters 762. Similarly, the second kernel can occupy the same number of clusters as the first kernel, or a different number of clusters from the first kernel. The first kernel allocated to the first plurality of clusters 760 may not have direct connections, nearest neighbor connection, or other connections to input ports and output ports (not shown) of the reconfigurable fabric of which the various clusters are a part. Communications between the clusters allocated to the first kernel and the input ports and the output ports of the reconfigurable fabric can be established by determining available routes 764 through the clusters allocated to the second kernel. These communication routes 764 can be established through the clusters allocated to the second kernel by calculating a porosity map through the second set of clusters. The porosity map can include data regarding elements of the second cluster that can be assigned as switching elements, where the switching elements can be coupled together to form a communication route. The switching elements can be “switched on” to establish one or more communication routes through the second cluster. In embodiments, the available routing through the second set of clusters changes during execution of the second kernel.

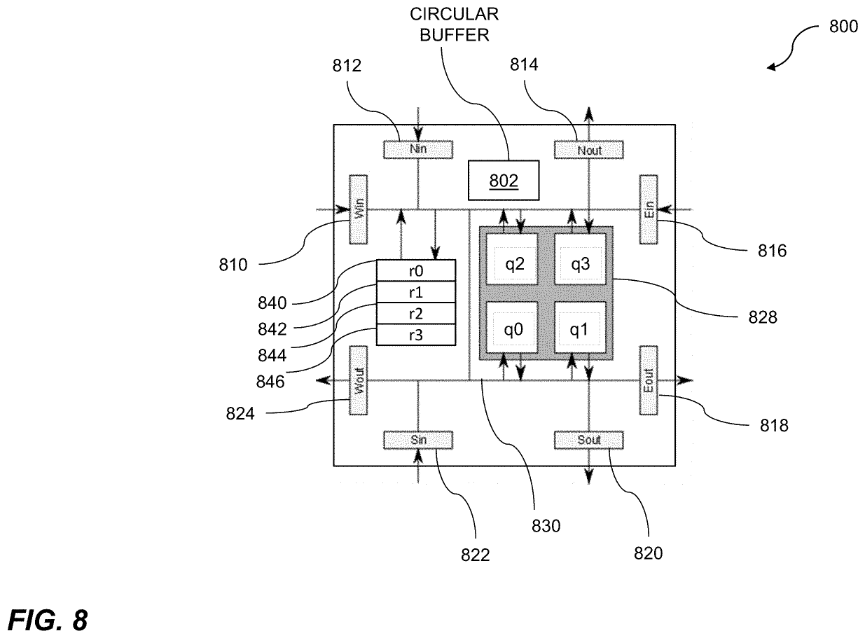

FIG. 8 shows a cluster for coarse-grained reconfigurable processing. The cluster 800 for coarse-grained reconfigurable processing can be used for reconfigurable fabric configuration using spatial and temporal routing. The reconfigurable fabric configuration includes allocating a plurality of clusters within a reconfigurable fabric, where the plurality of clusters is configured to execute one or more functions. The clusters can include processing elements, switching elements, storage elements, and so on. First and second spatial routings, and first and second temporal routings, are calculated all throughout the reconfigurable fabric. The spatial routings and the temporal routings are optimized, and the one or more functions are executed using the routings there were optimized. The spatial routings enable logical connections for data transfer among clusters. The temporal routings enable latency-aware data transfers among the clusters.

The cluster 800 comprises a circular buffer 802. The circular buffer 802 can be referred to as a main circular buffer or a switch-instruction circular buffer. In some embodiments, the cluster 800 comprises additional circular buffers corresponding to processing elements within the cluster. The additional circular buffers can be referred to as processor instruction circular buffers. The example cluster 800 comprises a plurality of logical elements, configurable connections between the logical elements, and a circular buffer 802 controlling the configurable connections. The logical elements can further comprise one or more of switching elements, processing elements, or storage elements. The example cluster 800 also comprises four processing elements—q0, q1, q2, and q3. The four processing elements can collectively be referred to as a “quad,” and can be jointly indicated by a grey reference box 828. In embodiments, there is intercommunication among and between each of the four processing elements. In embodiments, the circular buffer 802 controls the passing of data to the quad of processing elements 828 through switching elements. In embodiments, the four processing elements 828 comprise a processing cluster. In some cases, the processing elements can be placed into a sleep state. In embodiments, the processing elements wake up from a sleep state when valid data is applied to the inputs of the processing elements. In embodiments, the individual processors of a processing cluster share data and/or instruction caches. The individual processors of a processing cluster can implement message transfer via a bus or shared memory interface. Power gating can be applied to one or more processors (e.g. q1) in order to reduce power.

The cluster 800 can further comprise storage elements coupled to the configurable connections. As shown, the cluster 800 comprises four storage elements—r0 840, r1 842, r2 844, and r3 846. The cluster 800 further comprises a north input (Nin) 812, a north output (Nout) 814, an east input (Ein) 816, an east output (Eout) 818, a south input (Sin) 822, a south output (Sout) 820, a west input (Win) 810, and a west output (Wout) 824. The circular buffer 802 can contain switch instructions that implement configurable connections. For example, an instruction effectively connects the west input 810 with the north output 814 and the east output 818 and this routing is accomplished via bus 830. The cluster 800 can further comprise a plurality of circular buffers residing on a semiconductor chip where the plurality of circular buffers controls unique, configurable connections between and among the logical elements. The storage elements can include instruction random access memory (I-RAM) and data random access memory (D-RAM). The I-RAM and the D-RAM can be quad I-RAM and quad D-RAM, respectively, where the I-RAM and/or the D-RAM supply instructions and/or data, respectively, to the processing quad of a switching element.

A preprocessor or compiler can be configured to prevent data collisions within the circular buffer 802. The prevention of collisions can be accomplished by inserting no-op or sleep instructions into the circular buffer (pipeline). Alternatively, in order to prevent a collision on an output port, intermediate data can be stored in registers for one or more pipeline cycles before being sent out on the output port. In other situations, the preprocessor can change one switching instruction to another switching instruction to avoid a conflict. For example, in some instances the preprocessor can change an instruction placing data on the west output 824 to an instruction placing data on the south output 820, such that the data can be output on both output ports within the same pipeline cycle. In a case where data needs to travel to a cluster that is both south and west of the cluster 800, it can be more efficient to send the data directly to the south output port rather than to store the data in a register first, and then to send the data to the west output on a subsequent pipeline cycle.

An L2 switch interacts with the instruction set. A switch instruction typically has both a source and a destination. Data is accepted from the source and sent to the destination. There are several sources (e.g. any of the quads within a cluster; any of the L2 directions—North, East, South, West; a switch register; or one of the quad RAMs—data RAM, IRAM, PE/Co Processor Register). As an example, to accept data from any L2 direction, a “valid” bit is used to inform the switch that the data flowing through the fabric is indeed valid. The switch will select the valid data from the set of specified inputs. For this to function properly, only one input can have valid data, and the other inputs must all be marked as invalid. It should be noted that this fan-in operation at the switch inputs operates independently for control and data. There is no requirement for a fan-in mux to select data and control bits from the same input source. Data valid bits are used to select valid data, and control valid bits are used to select the valid control input. There are many sources and destinations for the switching element, which can result in excessive instruction combinations, so the L2 switch has a fan-in function enabling input data to arrive from one and only one input source. The valid input sources are specified by the instruction. Switch instructions are therefore formed by combining a number of fan-in operations and sending the result to a number of specified switch outputs.

In the event of a software error, multiple valid bits may arrive at an input. In this case, the hardware implementation can perform any safe function of the two inputs. For example, the fan-in could implement a logical OR of the input data. Any output data is acceptable because the input condition is an error, so long as no damage is done to the silicon. In the event that a bit is set to ‘1’ for both inputs, an output bit should also be set to ‘1’. A switch instruction can accept data from any quad or from any neighboring L2 switch. A switch instruction can also accept data from a register or a microDMA controller. If the input is from a register, the register number is specified. Fan-in may not be supported for many registers as only one register can be read in a given cycle. If the input is from a microDMA controller, a DMA protocol is used for addressing the resource.

For many applications, the reconfigurable fabric can be a DMA slave, which enables a host processor to gain direct access to the instruction and data RAMs (and registers) that are located within the quads in the cluster. DMA transfers are initiated by the host processor on a system bus. Several DMA paths can propagate through the fabric in parallel. The DMA paths generally start or finish at a streaming interface to the processor system bus. DMA paths may be horizontal, vertical, or a combination (as determined by a router). To facilitate high bandwidth DMA transfers, several DMA paths can enter the fabric at different times, providing both spatial and temporal multiplexing of DMA channels. Some DMA transfers can be initiated within the fabric, enabling DMA transfers between the block RAMs without external supervision. It is possible for a cluster “A”, to initiate a transfer of data between cluster “B” and cluster “C” without any involvement of the processing elements in clusters “B” and “C”. Furthermore, cluster “A” can initiate a fan-out transfer of data from cluster “B” to clusters “C”, “D”, and so on, where each destination cluster writes a copy of the DMA data to different locations within their Quad RAMs. A DMA mechanism may also be used for programming instructions into the instruction RAMs.

Accesses to RAMs in different clusters can travel through the same DMA path, but the transactions must be separately defined. A maximum block size for a single DMA transfer can be 8 KB. Accesses to data RAMs can be performed either when the processors are running or while the processors are in a low power “sleep” state. Accesses to the instruction RAMs and the PE and Co-Processor Registers may be performed during configuration mode. The quad RAMs may have a single read/write port with a single address decoder, thus allowing shared access by the quads and the switches. The static scheduler (i.e. the router) determines when a switch is granted access to the RAMs in the cluster. The paths for DMA transfers are formed by the router by placing special DMA instructions into the switches and determining when the switches can access the data RAMs. A microDMA controller within each L2 switch is used to complete data transfers. DMA controller parameters can be programmed using a simple protocol that forms the “header” of each access.

In embodiments, the computations that can be performed on a cluster for coarse-grained reconfigurable processing can be represented by a data flow graph. Data flow processors, data flow processor elements, and the like, are particularly well suited to processing the various nodes of data flow graphs. The data flow graphs can represent communications between and among agents, matrix computations, tensor manipulations, Boolean functions, and so on. Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of high quality data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PEs). The processing elements can include a processor, a data memory, an instruction memory, communications capabilities, and so on. Multiple PEs can be grouped, where the groups can include pairs, quads, octets, etc. The PEs arranged in configurations such as quads can be coupled to arithmetic units, where the arithmetic units can be coupled to or included in data processing units (DPUs). The DPUs can be shared between and among quads. The DPUs can provide arithmetic techniques to the PEs, communications between quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value of minus one plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0, then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. Once the clusters enter the configuration mode, various techniques, including direct memory access (DMA) can be used to load instructions from the kernel into instruction memories of the PEs. The clusters that were preprogrammed to enter configuration mode can also be preprogrammed to exit configuration mode. When configuration mode has been exited, execution of the one or more kernels loaded onto the clusters can commence.

Data flow processes that can be executed by data flow processors can be managed by a software stack. A software stack can include a set of subsystems, including software subsystems, which may be needed to create a software platform. The software platform can include a complete software platform. A complete software platform can include a set of software subsystems required to support one or more applications. A software stack can include both offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so on. The agent source code that can be operated on by the software development kit (SDK) can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as those based on GAMM, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

A reconfigurable fabric can include quads of elements. The elements of the reconfigurable fabric can include processing elements, switching elements, storage elements, and so on. An element such as a storage element can be controlled by a rotating circular buffer. In embodiments, the rotating circular buffer can be statically scheduled. The data operated on by the agents that are resident within the reconfigurable buffer can include tensors. Tensors can include one or more blocks. The reconfigurable fabric can be configured to process tensors, tensor blocks, tensors and blocks, etc. One technique for processing tensors includes deploying agents in a pipeline. That is, the output of one agent can be directed to the input of another agent. Agents can be assigned to clusters of quads, where the clusters can include one or more quads. Multiple agents can be pipelined when there are sufficient clusters of quads to which the agents can be assigned. Multiple pipelines can be deployed. Pipelining of the multiple agents can reduce the sizes of input buffers, output buffers, intermediate buffers, and other storage elements. Pipelining can further reduce memory bandwidth needs of the reconfigurable fabric.

Agents can be used to support dynamic reconfiguration of the reconfigurable fabric. The agents that support dynamic reconfiguration of the reconfigurable fabric can include interface signals in a control unit. The interface signals can include suspend, agent inputs empty, agent outputs empty, and so on. The suspend signal can be implemented using a variety of techniques such as a semaphore, a streaming input control signal, and the like. When a semaphore is used, the agent that is controlled by the semaphore can monitor the semaphore. In embodiments, a direct memory access (DMA) controller can wake the agent when the setting of the semaphore has been completed. The streaming control signal, if used, can wake a control unit if the control unit is sleeping. A response received from the agent can be configured to interrupt the host software.

The suspend semaphore can be asserted by runtime software in advance of commencing dynamic reconfiguration of the reconfigurable fabric. Upon detection of the semaphore, the agent can begin preparing for entry into a partially resident state. A partially resident state for the agent can include having the agent control unit resident after the agent kernel is removed. The agent can complete processing of any currently active tensor being operated on by the agent. In embodiments, a done signal and a fire signal may be sent to upstream or downstream agents, respectively. A done signal can be sent to the upstream agent to indicate that all data has been removed from its output buffer. A fire signal can be sent to a downstream agent to indicate that data in the output buffer is ready for processing by the downstream agent. The agent can continue to process incoming done signals and fire signals, but will not commence processing of any new tensor data after completion of the current tensor processing by the agent. The semaphore can be reset by the agent to indicate to a host that the agent is ready to be placed into partial residency. In embodiments, having the agent control unit resident after the agent kernel is removed comprises having the agent partially resident. A control unit may not assert one or more signals, nor expect one or more responses from a kernel in the agent, when a semaphore has been reset.

Other signals from an agent can be received by a host. The signals can include an agent inputs empty signal, an agent outputs empty signal, and so on. The agent inputs empty signal can be sent from the agent to the host and can indicate that the input buffers are empty. The agent inputs empty signal can only be sent from the agent when the agent is partially resident. The agent outputs empty signal can be sent from the agent to the host and can indicate that the output buffers are empty. The agent outputs empty can only be sent from the agent to the host when the agent is partially resident. When the runtime (host) software receives both signals, agent inputs empty and agent outputs empty, from the partially resident agent, the agent can be swapped out of the reconfigurable fabric and can become fully vacant.

Recall that an agent can be one of a plurality of agents that form a data flow graph. The data flow graph can be based on a plurality of subgraphs. The data flow graph can be based on agents which can support three states of residency: fully resident, partially resident, and fully vacant. A complete subsection (or subgraph) based on the agents that support the three states of residency can be swapped out of the reconfigurable fabric. The swapping out of the subsection can be based on asserting a suspend signal input to an upstream agent. The asserting of the suspend signal can be determined by the runtime software. When a suspend signal is asserted, the agent can stop consuming input data such as an input sensor. The tensor can queue within the input buffers of the agent. The agent kernel can be swapped out of the reconfigurable fabric, leaving the agent partially resident while the agent waits for the downstream agents to drain the output buffers for the agent. When an upstream agent is fully resident, the agent may not be able to be fully vacant because a fire signal might be sent to the agent by the upstream agent. When the upstream agent is partially resident or is fully vacant, then the agent can be fully vacated from the reconfigurable fabric. The agent can be fully vacated if it asserts both the input buffers empty and output buffers empty signals.

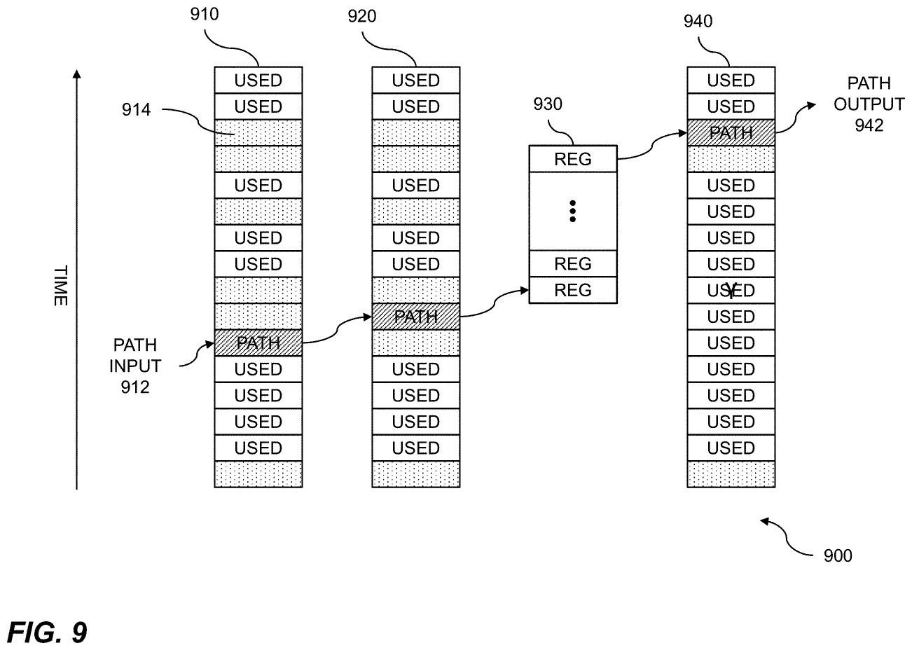

FIG. 9 shows routing through L2 switches and additional registers 900. Routing can be calculated through a reconfigurable fabric, where the reconfigurable fabric can include elements such as processing elements, storage elements, switching elements, and so on. The routing can include spatial routing and temporal routing. The spatial routing and the temporal routing can be used for reconfigurable fabric configuration. A plurality of clusters within a reconfigurable fabric is allocated, where the plurality of clusters is configured to execute one or more functions. A first spatial routing and a first temporal routing through the reconfigurable fabric are calculated. A second spatial routing and a second temporal routing through the reconfigurable fabric are calculated. The first and second spatial routings and the first and second temporal routings are optimized, and the one or more functions are executed, using routings that were optimized.

While spatial routing can enable a logical connection for data transfer between at least two clusters of the plurality of clusters within a reconfigurable fabric, a route specified for the spatial routing may not include any timing considerations for the data transfer. The spatial routing can include interconnects, communications channels, switching elements, and other “paths” through which data can be transferred. In addition to transferring the data, the data can be required to be received by a cluster within the reconfigurable fabric at a time when the data is needed for executing a given function. If data is not received by or available to the cluster on which the function is to be executed, then the cluster must idle or wait for the data to arrive, or might process incorrect data. Further, the transferring of the data may be delayed as one or more spatial routes become unavailable for one or more tic cycles. A spatial route can become unavailable as the spatial route is used for data transfer between at least two other clusters of the plurality of clusters within the reconfigurable fabric. When the spatial route is unavailable, data can be held in a register of an L2 switch. When the spatial route again becomes available, then the data transfer can resume.

Described throughout, the optimizing of spatial and/or temporal routings can place routing instructions in one or more clusters along a routing path within the reconfigurable fabric. The instructions can be routed through the reconfigurable fabric using a spatial routing. A spatial routing may not be uniquely assigned to two or more clusters within the reconfigurable fabric for the same time slot. That is, the spatial routing may be available to two or more clusters for an amount of time, may be available to two or more additional clusters for a subsequent amount of time, then may be made available again to the two or more clusters. The availability of a spatial routing can change based on a tic cycle. When instructions are being transferred along a spatial routing, the instructions can be held for one or more tic cycles in registers. The registers can include registers of one or more L2 switches. The instructions can be held temporarily as the instructions propagate along the spatial routing between two clusters. The clusters can include one or more elements, where the elements can include one or more of processing elements, switching elements, storage elements, and the like.

In the FIG. 900, usage of storage over time is shown. In the context of the reconfigurable fabric, time can be based on tic cycles. As time progresses (y-axis) based on the tic cycles, a given storage element may be used to store data, instructions, etc., or may be left unused 914 during the given tic cycle. In the figure, a path for spatial routing along which transfer latency occurs is shown. The latency occurs due to the spatial routing being available during a tic cycle, being unavailable for one or more tic cycles, being available again, and so on. Storage use over time is shown 910, 920, and 940. The storage can include registers, register files, direct memory access (DMA), and so on. The storage can include one or more registers of one or more L2 switches. The storage can be used for routing instructions or data along a spatial routing between two or more clusters. When a given storage element is unused during a tic cycle, the storage element can be used to hold instructions or data that are being transferred along the spatial routing. The locations can include cluster control instruction locations. In embodiments, to enable spatial routing, the routing instructions for the latency-aware data transfer can be placed in unused cluster control instruction locations within clusters of the reconfigurable fabric. The routing instructions can enable a path between or among the cluster control instruction locations. In embodiments, the unused cluster control instruction locations can be contained in instruction RAM (iRAM) instantiations. The iRAM instantiations can include storage elements, DRAM, register files, registers, and the like. In embodiments, the iRAM instantiations can be included within L2 switches.

A spatial routing can include a path through the reconfigurable fabric. In 900, the cluster control instruction locations used for routing instructions, data, etc., are marked “path”. The path can include path input 912 and path output 942. The spatial routing can provide a logical connection between clusters for data transfer. For a given tic cycle, a register along a spatial path between path input and path output can be available 910. An instruction or data can be stored in a storage element. At the next tic cycle, the spatial routing can be available for the path, so the instruction or data can be transferred to the next register of an L2 switch 920. Embodiments can include utilizing an additional register between two of the iRAM instantiations to enable temporal routing. The additional register, which can include a register of an L2 switch, holds the instructions or data until the spatial routing again becomes available. The instructions or data can be stored 930 for the number of tic cycles during which the path is not available. When the path becomes available again, the instructions or data can be transferred 940. Instruction or data transfer or storage continues over a number of tic cycles while the instructions or data transfer from path input 912 to path output 942.

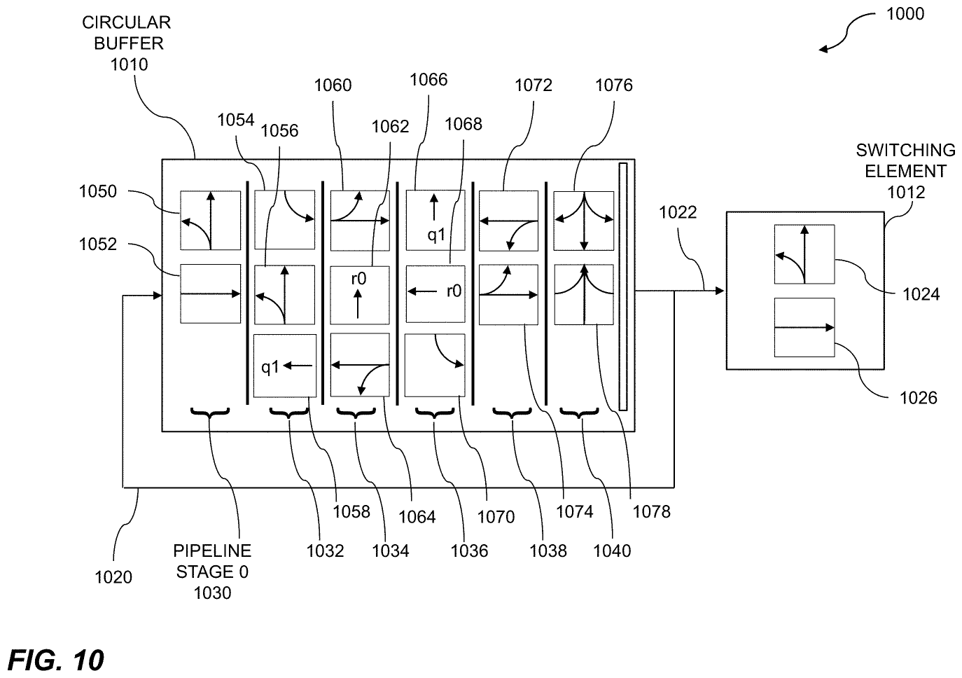

FIG. 10 shows a block diagram 1000 of a circular buffer. The circular buffer can include a switching element 1012 corresponding to the circular buffer. The circular buffer and the corresponding switching element can be used in part for reconfigurable fabric configuration using spatial and temporal routing. Using the circular buffer 1010 and the corresponding switching element 1012, data can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The block diagram 1000 describes a processor-implemented method for data manipulation. The circular buffer 1010 contains a plurality of pipeline stages. Each pipeline stage contains one or more instructions, up to a maximum instruction depth. In the embodiment shown in FIG. 10, the circular buffer 1010 is a 6×3 circular buffer, meaning that it implements a six-stage pipeline with an instruction depth of up to three instructions per stage (column). Hence, the circular buffer 1010 can include one, two, or three switch instruction entries per column. In some embodiments, the plurality of switch instructions per cycle can comprise two or three switch instructions per cycle. However, in certain embodiments, the circular buffer 1010 supports only a single switch instruction in a given cycle. In the example 1000 shown, Pipeline Stage 0 1030 has an instruction depth of two instructions 1050 and 1052. Though the remaining pipeline stages 1-5 are not textually labeled in the FIG. 1000, the stages are indicated by callouts 1032, 1034, 1036, 1038, and 1040. Pipeline stage 1 1032 has an instruction depth of three instructions 1054, 1056, and 1058. Pipeline stage 2 1034 has an instruction depth of three instructions 1060, 1062, and 1064. Pipeline stage 3 1036 also has an instruction depth of three instructions 1066, 1068, and 1070. Pipeline stage 4 1038 has an instruction depth of two instructions 1072 and 1074. Pipeline stage 5 1040 has an instruction depth of two instructions 1076 and 1078. In embodiments, the circular buffer 1010 includes 64 columns. During operation, the circular buffer 1010 rotates through configuration instructions. The circular buffer 1010 can dynamically change operation of the logical elements based on the rotation of the circular buffer. The circular buffer 1010 can comprise a plurality of switch instructions per cycle for the configurable connections.

The instruction 1052 is an example of a switch instruction. In embodiments, each cluster has four inputs and four outputs, each designated within the cluster's nomenclature as “north,” “east,” “south,” and “west” respectively. For example, the instruction 1052 in the diagram 1000 is a west-to-east transfer instruction. The instruction 1052 directs the cluster to take data on its west input and send out the data on its east output. In another example of data routing, the instruction 1050 is a fan-out instruction. The instruction 1050 instructs the cluster to take data from its south input and send out on the data through both its north output and its west output. The arrows within each instruction box indicate the source and destination of the data. The instruction 1078 is an example of a fan-in instruction. The instruction 1078 takes data from the west, south, and east inputs and sends out the data on the north output. Therefore, the configurable connections can be considered to be time multiplexed.

In embodiments, the clusters implement multiple storage elements in the form of registers. In the example 1000 shown, the instruction 1062 is a local storage instruction. The instruction 1062 takes data from the instruction's south input and stores it in a register (r0). Another instruction (not shown) is a retrieval instruction. The retrieval instruction takes data from a register (e.g. r0) and outputs it from the instruction's output (north, south, east, west). Some embodiments utilize four general purpose registers, referred to as registers r0, r1, r2, and r3. The registers are, in embodiments, storage elements which store data while the configurable connections are busy with other data. In embodiments, the storage elements are 32-bit registers. In other embodiments, the storage elements are 64-bit registers. Other register widths are possible.

The obtaining data from a first switching element and the sending the data to a second switching element can include a direct memory access (DMA). A DMA transfer can continue while valid data is available for the transfer. A DMA transfer can terminate when it has completed without error, or when an error occurs during operation. Typically, a cluster that initiates a DMA transfer will request to be brought out of sleep state when the transfer is complete. This waking is achieved by setting control signals that can control the one or more switching elements. Once the DMA transfer is initiated with a start instruction, a processing element or switching element in the cluster can execute a sleep instruction to place itself to sleep. When the DMA transfer terminates, the processing elements and/or switching elements in the cluster can be brought out of sleep after the final instruction is executed. Note that if a control bit can be set in the register of the cluster that is operating as a slave in the transfer, that cluster can also be brought out of a sleep state if it is asleep during the transfer.

The cluster that is involved in a DMA and can be brought out of sleep after the DMA terminates can determine that it has been brought out of a sleep state based on the code that is executed. A cluster can be brought out of a sleep state based on the arrival of a reset signal and the execution of a reset instruction. The cluster can be brought out of sleep by the arrival of valid data (or control) following the execution of a switch instruction. A processing element or switching element can determine why it was brought out of a sleep state by the context of the code that the element starts to execute. A cluster can be awoken during a DMA operation by the arrival of valid data. The DMA instruction can be executed while the cluster remains asleep and awaits the arrival of valid data. Upon arrival of the valid data, the cluster is woken and the data stored. Accesses to one or more data random access memories (RAMs) can be performed when the processing elements and the switching elements are operating. The accesses to the data RAMs can also be performed while the processing elements and/or switching elements are in a low power sleep state.

In embodiments, the clusters implement multiple processing elements in the form of processor cores, referred to as cores q0, q1, q2, and q3. In embodiments, four cores are used, though any number of cores can be implemented. The instruction 1058 is a processing instruction. The instruction 1058 takes data from the instruction's east input and sends it to a processor q1 for processing. The processors can perform logic operations on the data, including, but not limited to, a shift operation, a logical AND operation, a logical OR operation, a logical NOR operation, a logical XOR operation, an addition, a subtraction, a multiplication, and a division. Thus, the configurable connections can comprise one or more of a fan-in, a fan-out, and a local storage.

In the example 1000 shown, the circular buffer 1010 rotates instructions in each pipeline stage into switching element 1012 via a forward data path 1022, and also back to a pipeline stage 0 1030 via a feedback data path 1020. Instructions can include switching instructions, storage instructions, and processing instructions, among others. The feedback data path 1020 can allow instructions within the switching element 1012 to be transferred back to the circular buffer. Hence, the instructions 1024 and 1026 in the switching element 1012 can also be transferred back to pipeline stage 0 as the instructions 1050 and 1052. In addition to the instructions depicted on FIG. 10, a no-op instruction can also be inserted into a pipeline stage. In embodiments, a no-op instruction causes execution to not be performed for a given cycle. In effect, the introduction of a no-op instruction can cause a column within the circular buffer 1010 to be skipped in a cycle. In contrast, not skipping an operation indicates that a valid instruction is being pointed to in the circular buffer. A sleep state can be accomplished by not applying a clock to a circuit, performing no processing within a processor, removing a power supply voltage or bringing a power supply to ground, storing information into a non-volatile memory for future use and then removing power applied to the memory, or by similar techniques. A sleep instruction that causes no execution to be performed until a predetermined event occurs which causes the logical element to exit the sleep state can also be explicitly specified. The predetermined event can be the arrival or availability of valid data. The data can be determined to be valid using null convention logic (NCL). In embodiments, only valid data can flow through the switching elements and invalid data points (Xs) are not propagated by instructions.

In some embodiments, the sleep state is exited based on an instruction applied to a switching fabric. The sleep state can, in some embodiments, only be exited by a stimulus external to the logical element and not based on the programming of the logical element. The external stimulus can include an input signal, which in turn can cause a wake up or an interrupt service request to execute on one or more of the logical elements. An example of such a wake-up request can be seen in the instruction 1058, assuming that the processor q1 was previously in a sleep state. In embodiments, when the instruction 1058 takes valid data from the east input and applies that data to the processor q1, the processor q1 wakes up and operates on the received data. In the event that the data is not valid, the processor q1 can remain in a sleep state. At a later time, data can be retrieved from the q1 processor, e.g. by using an instruction such as the instruction 1066. In the case of the instruction 1066, data from the processor q1 is moved to the north output. In some embodiments, if Xs have been placed into the processor q1, such as during the instruction 1058, then Xs would be retrieved from the processor q1 during the execution of the instruction 1066 and would be applied to the north output of the instruction 1066.

A collision occurs if multiple instructions route data to a particular port in a given pipeline stage. For example, if instructions 1052 and 1054 are in the same pipeline stage, they will both send data to the east output at the same time, thus causing a collision since neither instruction is part of a time-multiplexed fan-in instruction (such as the instruction 1078). To avoid potential collisions, certain embodiments use preprocessing, such as by a compiler, to arrange the instructions in such a way that there are no collisions when the instructions are loaded into the circular buffer. Thus, the circular buffer 1010 can be statically scheduled in order to prevent data collisions. Thus, in embodiments, the circular buffers are statically scheduled. In embodiments, when the preprocessor detects a data collision, the scheduler changes the order of the instructions to prevent the collision. Alternatively, or additionally, the preprocessor can insert further instructions such as storage instructions (e.g. the instruction 1062), sleep instructions, or no-op instructions, to prevent the collision. Alternatively, or additionally, the preprocessor can replace multiple instructions with a single fan-in instruction. For example, if a first instruction sends data from the south input to the north output and a second instruction sends data from the west input to the north output in the same pipeline stage, the first and second instruction can be replaced with a fan-in instruction that routes the data from both of those inputs to the north output in a deterministic way to avoid a data collision. In this case, the machine can guarantee that valid data is only applied on one of the inputs for the fan-in instruction.

Returning to DMA, a channel configured as a DMA channel requires a flow control mechanism that is different from regular data channels. A DMA controller can be included in interfaces to master DMA transfer through the processing elements and switching elements. For example, if a read request is made to a channel configured as DMA, the Read transfer is mastered by the DMA controller in the interface. It includes a credit count that calculates the number of records in a transmit (Tx) FIFO that are known to be available. The credit count is initialized based on the size of the Tx FIFO. When a data record is removed from the Tx FIFO, the credit count is increased. If the credit count is positive, and the DMA transfer is not complete, an empty data record can be inserted into a receive (Rx) FIFO. The memory bit is set to indicate that the data record should be populated with data by the source cluster. If the credit count is zero (meaning the Tx FIFO is full), no records are entered into the Rx FIFO. The FIFO to fabric block will ensure that the memory bit is reset to 0, thereby preventing a microDMA controller in the source cluster from sending more data.

Each slave interface manages four interfaces between the FIFOs and the fabric. Each interface can contain up to fifteen data channels. Therefore, a slave should manage read/write queues for up to sixty channels. Each channel can be programmed to be a DMA channel, or a streaming data channel. DMA channels are managed using a DMA protocol. Streaming data channels are expected to maintain their own form of flow control using the status of the Rx FIFOs (obtained using a query mechanism). Read requests to slave interfaces use one of the flow control mechanisms described previously.

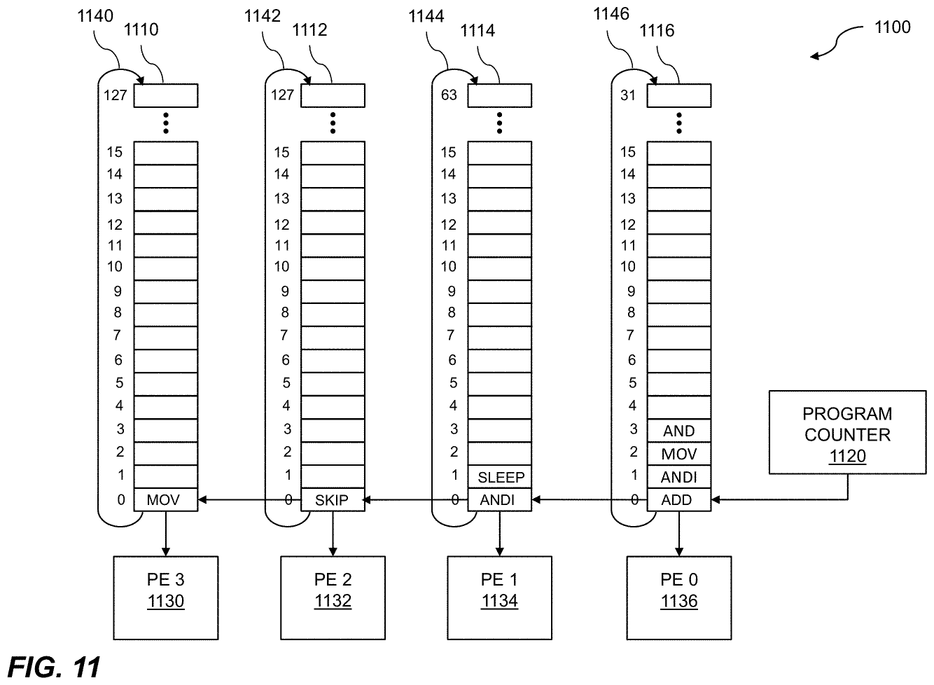

FIG. 11 illustrates circular buffers and processing elements. A diagram 1100 indicates example instruction execution for processing elements. The processing elements can include a portion of or all of the elements within a reconfigurable fabric. The instruction execution can include instructions for reconfigurable fabric configuration using spatial and temporal routing. A plurality of clusters within a reconfigurable fabric is allocated. The plurality of clusters is configured to execute one or more functions, where the functions can include logical functions, arithmetic functions, complex functions, and so on. A first spatial routing and a first temporal routing, and a second spatial routing and a second temporal routing, are calculated through the reconfigurable fabric. The first and second spatial routings and the first and second temporal routings are optimized. The one or more functions are executed using routings that were optimized. The spatial routings enable logical connections for transfer between at least two clusters. The temporal routings enable a latency-aware data transfer between at least two clusters.

A circular buffer 1110 feeds a processing element 1130. A second circular buffer 1112 feeds another processing element 1132. A third circular buffer 1114 feeds another processing element 1134. A fourth circular buffer 1116 feeds another processing element 1136. The four processing elements 1130, 1132, 1134, and 1136 can represent a quad of processing elements. In embodiments, the processing elements 1130, 1132, 1134, and 1136 are controlled by instructions received from the circular buffers 1110, 1112, 1114, and 1116. The circular buffers can be implemented using feedback paths 1140, 1142, 1144, and 1146, respectively. In embodiments, the circular buffer can control the passing of data to a quad of processing elements through switching elements, where each of the quad of processing elements is controlled by four other circular buffers (as shown in the circular buffers 1110, 1112, 1114, and 1116) and where data is passed back through the switching elements from the quad of processing elements where the switching elements are again controlled by the main circular buffer. In embodiments, a program counter 1120 is configured to point to the current instruction within a circular buffer. In embodiments with a configured program counter, the contents of the circular buffer are not shifted or copied to new locations on each instruction cycle. Rather, the program counter 1120 is incremented in each cycle to point to a new location in the circular buffer. The circular buffers 1110, 1112, 1114, and 1116 can contain instructions for the processing elements. The instructions can include, but are not limited to, move instructions, skip instructions, logical AND instructions, logical AND-Invert (e.g. ANDI) instructions, logical OR instructions, mathematical ADD instructions, shift instructions, sleep instructions, and so on. A sleep instruction can be usefully employed in numerous situations. The sleep state can be entered by an instruction within one of the processing elements. One or more of the processing elements can be in a sleep state at any given time. In some embodiments, a “skip” can be performed on an instruction and the instruction in the circular buffer can be ignored and the corresponding operation not performed.

In some embodiments, the circular buffers 1110, 1112, 1114, and 1116 could all have the same length, for example, 128 instructions. However, in other embodiments, the plurality of circular buffers can have differing lengths. That is, the plurality of circular buffers can comprise circular buffers of differing sizes. As shown in FIG. 11, the first two circular buffers 1110 and 1112 have a length of 128 instructions, the third circular buffer 1114 has a length of 64 instructions, and the fourth circular buffer 1116 has a length of 32 instructions, but other circular buffer lengths are also possible. The plurality of circular buffers that have differing lengths can resynchronize with a zeroth pipeline stage for each of the plurality of circular buffers. The circular buffers of differing sizes can restart at a same time step. In other embodiments, the plurality of circular buffers includes a first circular buffer repeating at one frequency and a second circular buffer repeating at a second frequency. In this situation, the first circular buffer is of one length. When the first circular buffer finishes through a loop, it can restart operation at the beginning, even though the second, longer circular buffer has not yet completed its operations. When the second circular buffer reaches completion of its loop of operations, the second circular buffer can restart operations from its beginning.

As can be seen in FIG. 11, different circular buffers can have different instruction sets within them. For example, the first circular buffer 1110 contains a MOV instruction. The second circular buffer 1112 contains a SKIP instruction. The third circular buffer 1114 contains a SLEEP instruction and an ANDI instruction. The fourth circular buffer 1116 contains an AND instruction, a MOVE instruction, an ANDI instruction, and an ADD instruction. The operations performed by the processing elements 1130, 1132, 1134, and 1136 are dynamic and can change over time, based on the instructions loaded into the respective circular buffers. As the circular buffers rotate, new instructions can be executed by the respective processing element.

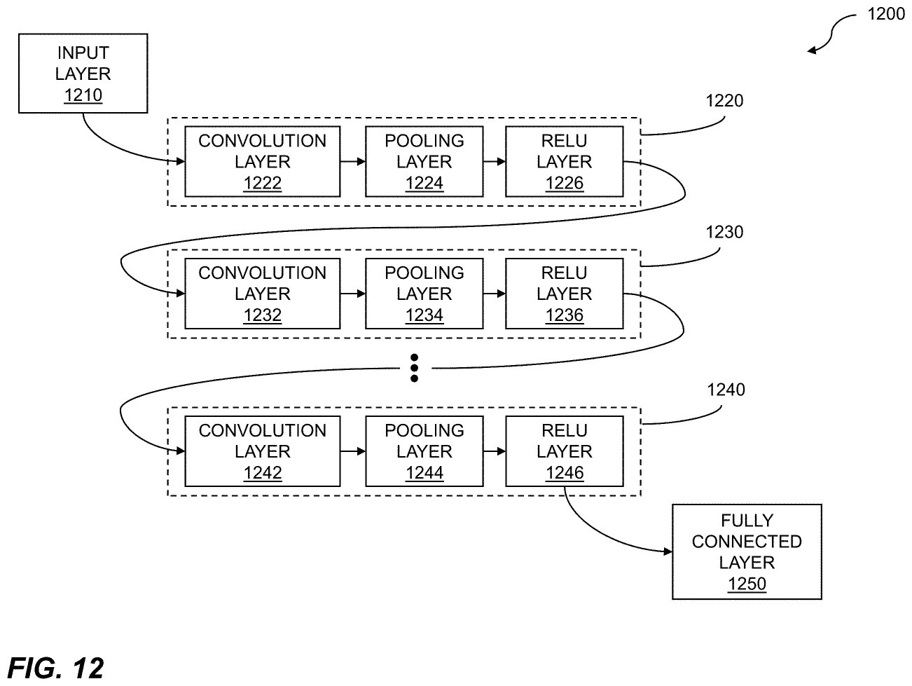

FIG. 12 shows a deep learning block diagram. The deep learning block diagram 1200 can include a neural network such as a deep neural network (DNN), a convolutional neural network (CNN), a recurrent neural network (RNN), and so on. A convolutional neural network or other neural network can be based on layers, where the layers can include input layers, output layers, fully connected layers, convolution layers, pooling layers, rectified linear unit (ReLU) layers, and so on. The layers can include machine learned layers for data manipulation. The reconfigurable fabric can include processing elements, switching elements, storage elements, etc. The reconfigurable fabric can be used to perform various operations such as logical operations. Deep learning can support reconfigurable fabric configuration using spatial and temporal routing. A plurality of clusters within a reconfigurable fabric is allocated, where the plurality of clusters is configured to execute one or more functions. A first spatial routing and a first temporal routing are calculated through the reconfigurable fabric, and a second spatial routing and a second temporal routing are calculated through the reconfigurable fabric. The first and second spatial routings and the first and second temporal routings are optimized. The one or more functions are executed using routings that were optimized.

The deep learning block diagram 1200 can include various layers, where the layers can include an input layer, hidden layers, a fully connected layer, and so on. In some embodiments, the deep learning block diagram can include a classification layer. The input layer 1210 can receive input data, where the input data can include a first obtained data group, a second obtained data group, a third obtained data group, a fourth obtained data group, etc. The obtaining of the data groups can be performed in a first locality, a second locality, a third locality, a fourth locality, and so on, respectively. The input layer can then perform processing such as partitioning obtained data into non-overlapping partitions. The deep learning block diagram 1200, which can represent a network such as a convolutional neural network, can contain a plurality of hidden layers. While three hidden layers, hidden layer 1220, hidden layer 1230, and hidden layer 1240 are shown, other numbers of hidden layers may be present. Each hidden layer can include layers that perform various operations, where the various layers can include a convolution layer, a pooling layer, and a rectifier layer such as a rectified linear unit (ReLU) layer. Thus, layer 1220 can include convolution layer 1222, pooling layer 1224, and ReLU layer 1226; layer 1230 can include convolution layer 1232, pooling layer 1234, and ReLU layer 1236; and layer 1240 can include convolution layer 1242, pooling layer 1244, and ReLU layer 1246. The convolution layers 1222, 1232, and 1242 can perform convolution operations; the pooling layers 1224, 1234, and 1244 can perform pooling operations, including max pooling, such as data down-sampling; and the ReLU layers 1226, 1236, and 1246 can perform rectification operations. A convolutional layer can reduce the amount of data feeding into a fully connected layer. The deep learning block diagram 1200 can include a fully connected layer 1250. The fully connected layer can be connected to each data point from the one or more convolutional layers.

Data flow processors can be implemented within a reconfigurable fabric. Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PEs). The processing elements can include a processor, a data memory, an instruction memory, communications capabilities, and so on. Multiple PEs can be grouped, where the groups can include pairs, quads, octets, etc. The PEs configured in arrangements such as quads can be coupled to arithmetic units, where the arithmetic units can be coupled to or included in data processing units (DPUs). The DPUs can be shared between and among quads. The DPUs can provide arithmetic techniques to the PEs, communications between quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value minus one plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0, then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. Once the cluster enters the configuration mode, various techniques, including direct memory access (DMA) can be used to load instructions from the kernel into instruction memories of the PEs. The clusters that were preprogrammed into configuration mode can be preprogrammed to exit configuration mode. When configuration mode has been exited, execution of the one or more kernels loaded onto the clusters can commence.

Data flow processes that can be executed by data flow processors can be managed by a software stack. A software stack can include a set of subsystems, including software subsystems, which may be needed to create a software platform. The software platform can include a complete software platform. A complete software platform can include a set of software subsystems required to support one or more applications. A software stack can include offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so on. The agent source code that can be operated on by the software development kit (SDK) can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as machine learning techniques based on GAMM, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

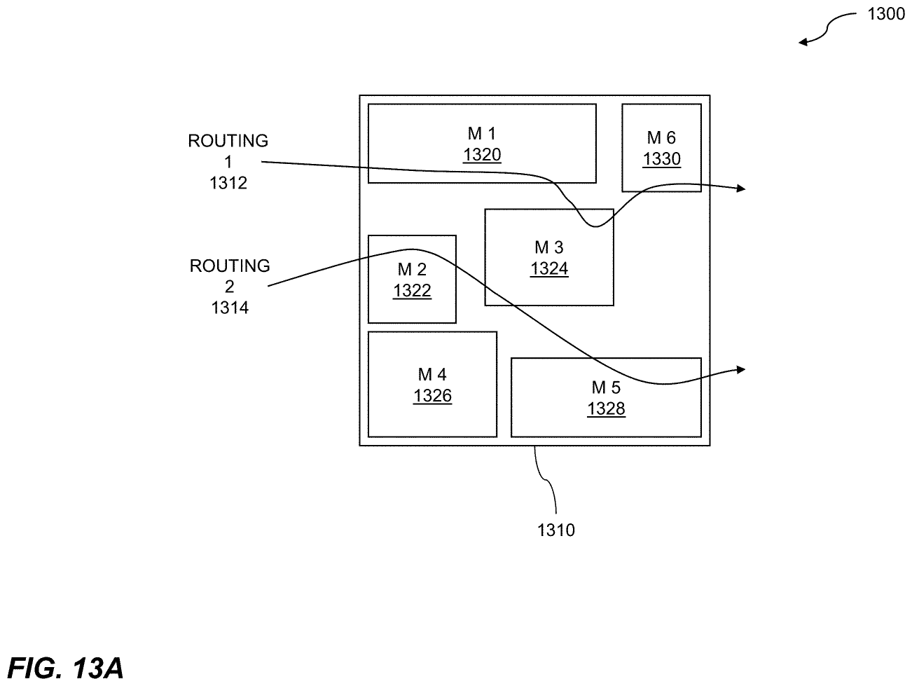

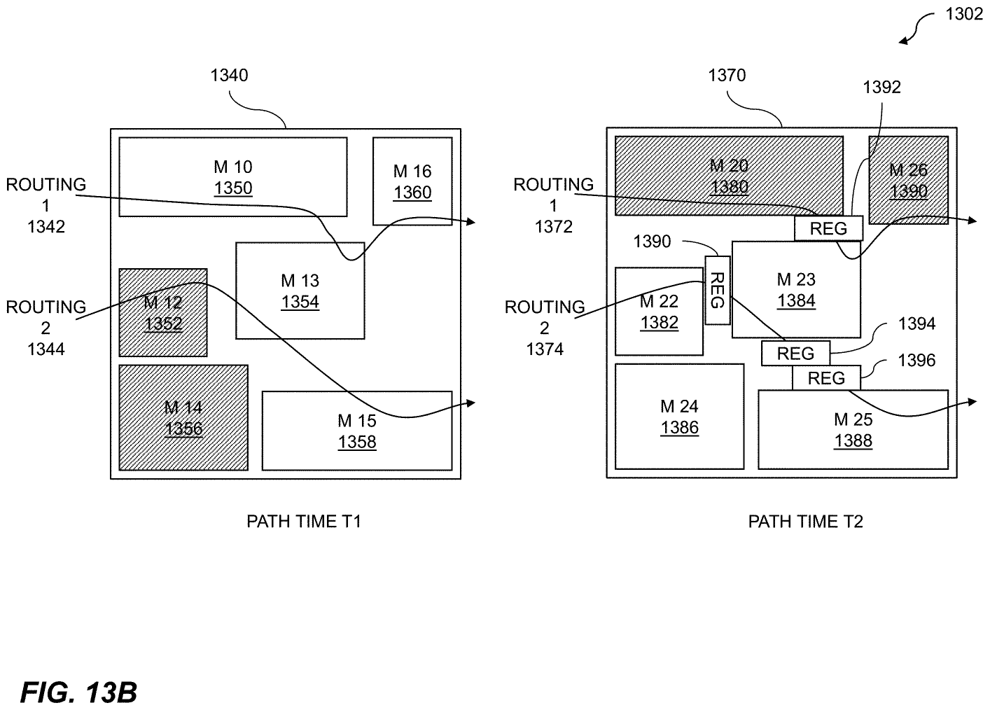

FIG. 13A shows spatial cluster routing 1300. Routes can be calculated through a reconfigurable fabric, where the routes that are calculated can include spatial routes and temporal routes. The spatial and temporal routes are used for reconfigurable fabric configuration. The reconfigurable fabric can be configured for data manipulation. A plurality of clusters within a reconfigurable fabric is allocated, where the plurality of clusters is configured to execute one or more functions. Routings through the reconfigurable fabric are calculated, where the routings include a first spatial routing and a first temporal routing. Other routings through the reconfigurable fabric are calculated, where the other routings include a second spatial routing and a second temporal routing. The routings are optimized, where the routings include the first and second spatial routings and the first and second temporal routings. The one or more functions are executed using routings that were optimized.

Turning first to spatial routings, routes can be calculated through a reconfigurable fabric 1310 within which one or more pluralities of clusters have been allocated. The clusters that can be allocated can include functions, co-processors, machines, etc. Allocated clusters including machines are shown, where the machines include m1 1320, m2 1322, m3 1324, m4 1326, m5 1328, and m6 1330. Other numbers of machines, co-processors, functions, and the like, can be allocated. The routes can be calculated based on available interconnection paths, communications channels, or switching elements within the reconfigurable array. The routings can enable data transfer between two clusters by routing the data through other clusters. In embodiments, a first spatial routing, routing 1 1312, can enable a logical connection for data transfer between at least two clusters of the plurality of clusters. The logical path for data transfer can route through machines m1, m3, and m6. Other logical connections can be established by calculating paths. The other logical connections can connect the at least two clusters mentioned previously, or can connect further clusters. In embodiments, a second routing, routing 2 1314, can enable a logical connection for data transfer between at least two additional clusters of the plurality of clusters.

FIG. 13B shows temporal cluster routing 1302. As mentioned throughout, reconfigurable fabric configuration uses spatial and temporal routing for data manipulation. The data manipulation can be based on executing one or more functions on clusters within a reconfigurable fabric. The functions can be executed based on connections for data transfer between at least two clusters within the reconfigurable fabric. While the one or more spatial routings can enable a logical connection for data transfer between at least two clusters of the plurality of clusters within the reconfigurable fabric, one or more temporal routings can be used to ensure that data arrives at a cluster, co-processor, machine, function, or the like. The arrival of the data can be timed to occur when the cluster requires the data so that the function, for example, can be executed.

Routings, including temporal routings, can be calculated through the reconfigurable fabric. In the case of temporal routings, the temporal routings can enable a latency-aware data transfer between the at least two clusters, between the at least two additional clusters, and so on. Latency-awareness can include timing data transfer between at least two clusters so that data arrives at the clusters when needed by a function, co-processor, machine, or the like. Data arriving exactly when needed reduces or eliminates executing wait cycles while waiting for data. Recall that optimizing spatial routings and/or temporal routings can place routing instructions in one or more clusters along a routing path within the reconfigurable fabric. The routing instructions can be used to direct data and control data transfers along spatial routings or temporal routings. In embodiments, to enable spatial routing, the routing instructions can be placed in unused cluster control instruction locations within clusters of the reconfigurable fabric. Discussed throughout, the unused cluster control instruction locations can be contained in instruction RAM (iRAM) instantiations. The unused cluster control instruction locations of the iRAM instantiations can be included within L2 switches. While the routing instructions can be placed in unused cluster control instruction locations, the placement alone may not be sufficient to handle latency-aware data transfer. In embodiments, an additional register between two of the iRAM instantiations can enable temporal routing. The additional register between iRAM instantiations can introduce a timing factor into the data transfer. In embodiments, the additional register adds delay in routing instruction propagation within the reconfigurable fabric.

Two routings through allocated clusters within a reconfigurable fabric 1340 are shown. Routing 1 1342 can pass through m10 1350, m13 1354, and m16 1360, and routing 2 can pass through m12 1352, m13 1354, and m15 1358 without passing through m14 1356. As calculated, the routings routing 1 1342 and routing 2 1344 may not accomplish latency-aware data transfer. To accomplish latency-aware data transfer, additional registers can be used to add delay in routing instruction propagation within the reconfigurable fabric. Routings with added delay are shown within a reconfigurable fabric 1370. Routing 1 1372 can include added register 1392. Routing 2 1374 can include added registers 1390, 1394, and 1396.

In addition to ensuring that data can be routed to the proper cluster within the reconfigurable fabric at the appropriate time, routings through the clusters can be available for some clusters at one time, and available to other clusters at other times. In the example, routing 1 1342 can be available through machines m10 1350, m13 1354, and m16 1360 at a first time (T1), while routing 2 can be unavailable because the routing through m12 1352 is being used to handle data transfer between other clusters. At a second time (T2), routing 1 1372 may be unavailable because the routing through m20 1380 and m26 1390 is being used to handle data transfer between other clusters. Routing 2 1374 can be available through m22 1382, m23 1384, and m25 1388 without passing through m24 1386.

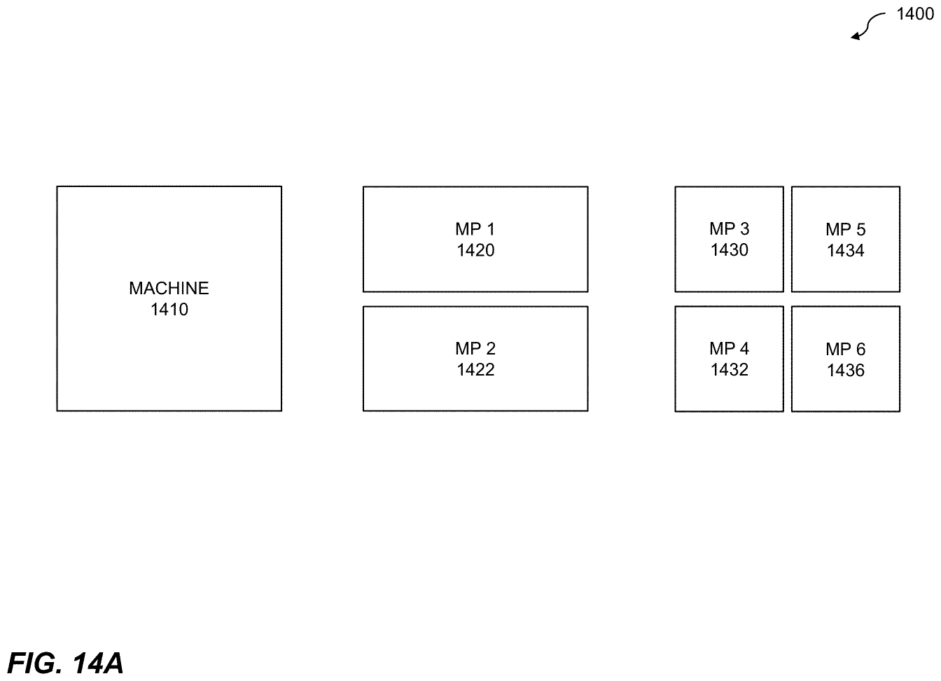

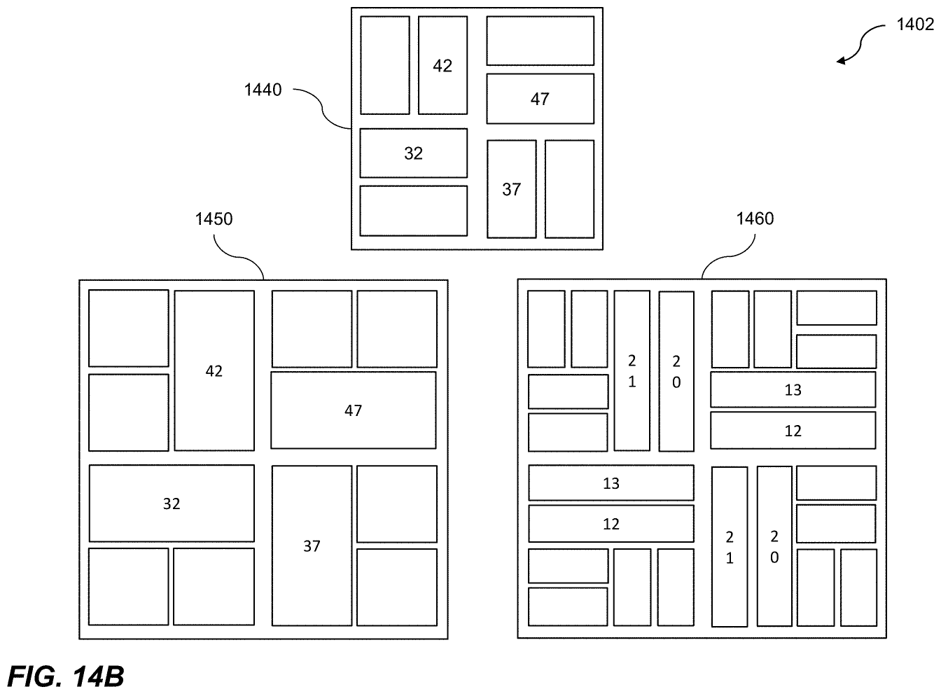

FIG. 14A illustrates machine partitioning. A machine, which can include a reconfigurable fabric, can be based on elements such as processing elements, storage elements, communications elements, and so on. The machine can be partitioned in order to reduce the complexity of allocating one or more functions to clusters of processing elements within the reconfigurable fabric. The partitioning can be used for reconfigurable fabric configuration using spatial and temporal routing. The allocating of clusters can include allocating or assigning one or more kernels, which can implement the one or more functions, to clusters of processing elements. The allocating is complicated by the need to identify a sufficient number of unallocated processing elements within the reconfigurable fabric to which the kernel can be assigned, and the need to route data to the inputs or from the outputs of the kernel. Since not all elements within the reconfigurable fabric are in direct communication with inputs and outputs (I/Os) of the reconfigurable fabric, routes must be established between elements which are not adjacent to the I/Os and the I/Os. The availability of such routes depends on the kernels that are assigned to clusters of processing elements, and the timing requirements for the data needed by the kernels.

Various techniques can be used for allocating clusters of processing elements to kernels. The problem of allocation can be thought of as placing the kernels into the reconfigurable fabric, much like the classic “bin packing” problem, in which one tries to efficiently place objects (the kernels) of different sizes into a bin (the reconfigurable fabric). The efficient manner of placement minimizes the number of clusters that cannot be allocated to additional kernels. As kernels are added to the reconfigurable fabric, the remaining “free space” or unallocated clusters of processing elements can be stored by describing the free space as a geometric shape such as a rectangle. The free space can be partitioned and the partitions can be allocated to additional kernels. The choices made for partitioning the free space will influence or perhaps limit how future kernels can be placed. Rather than adopting the rigid choice of partitioning free space vertically or horizontally, a technique for maintaining a set of empty rectangles that can overlap is developed.

Techniques for machine partitioning are shown 1400. A machine 1410 can include one or more clusters of elements, where the elements can include one or more of processing elements, storage elements, switching elements, and so on. The machine can be partitioned into rectangles. In embodiments, the rectangles can include overlapping rectangles. The machine 1410 can be partitioned horizontally to form two or more partitions such as machine partition mp 1 1420, and machine partition mp 2 1422. The machine 1410 can be partitioned further into other numbers of horizontal partitions. The machine 1410, or the horizontal machine partitions 1420 and 1422 can be partitioned vertically. Examples of horizontal machine partitions that can be further partitioned vertically can include machine partition mp 3 1430, machine partition mp 4 1432, machine partition mp 5 1434, machine partition mp 6 1436, and so on. Examples of machine groupings 1402 are shown in FIG. 14B.

FIG. 14B shows hierarchical machine groupings. A machine can be partitioned into machine partitions, and the machine partitions can be organized into machine groupings. The machine groups can be joined or “mounted” to form co-processors that can span two or more machines. Similarly, machines can be split or “unmounted” to form smaller machines, where the smaller machine may form co-processors that require fewer computational resources. The hierarchical machine groupings can support reconfigurable fabric configuration using spatial and temporal routing. Examples for hierarchical machine groupings are shown 1402. The groupings can be based on sizes of clusters within a reconfigurable fabric, on sizes of co-processors, and the like. A grouping can include horizontal and vertical rectangular partitions 1440; rectangular and square partitions 1450, combinations of vertically oriented or horizontally oriented rectangular partitions, 1460, and so on.

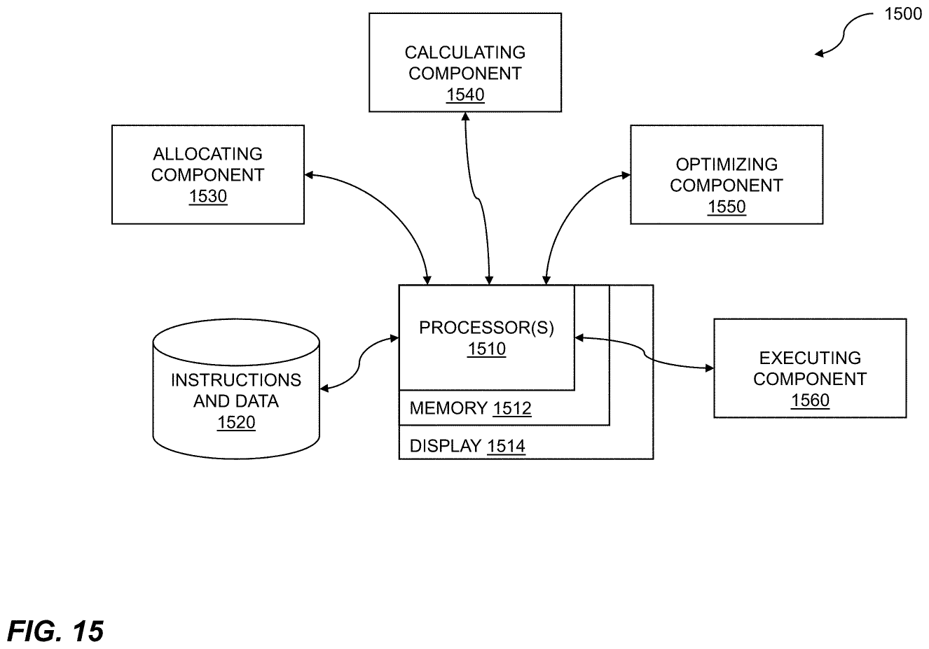

FIG. 15 is a system diagram for reconfigurable fabric configuration. Data manipulation is based on reconfigurable fabric configuration using spatial and temporal routing. The system 1500 can include one or more processors 1510 coupled to a memory 1512 which stores instructions. The system 1500 can include a display 1514 coupled to the one or more processors 1510 for displaying data, intermediate steps, instructions, and so on. In embodiments, one or more processors 1510 are coupled to the memory 1512 where the one or more processors, when executing the instructions which are stored, are configured to: allocate a plurality of clusters within a reconfigurable fabric, wherein the plurality of clusters is configured to execute one or more functions; calculate a first spatial routing and a first temporal routing through the reconfigurable fabric; calculate a second spatial routing and a second temporal routing through the reconfigurable fabric; optimize the first and second spatial routings and the first and second temporal routings; and execute the one or more functions, using routings that were optimized

The system 1500 can include a collection of instructions and data 1520. The instructions and data 1520 may be stored in storage such as electronic storage coupled to the one or more processors, a database, one or more statically linked libraries, one or more dynamically linked libraries, precompiled headers, source code, flow graphs, kernels, or other suitable formats. The instructions can include instructions for spatial and temporal data routing from one or more kernels through another kernel within a reconfigurable fabric. The instructions can include satisfiability solver techniques, machine learning or deep learning techniques, neural network techniques, agents, and the like. The instructions can include mapping constraints, porosity maps, or satisfiability models. The system 1500 can include an allocating component 1530. The allocating component 1530 can include functions and instructions for allocating a plurality of clusters within a reconfigurable fabric. The plurality of clusters can be configured to execute one or more functions, where the functions can include logical functions, arithmetical functions, complex computations, and the like. The reconfigurable fabric can include clusters, where the clusters can include processing elements, switching elements, storage elements, communications paths, and so on. The plurality of kernels that is allocated includes at least a first kernel and a second kernel.

The system 1500 can include a calculating component 1540. The calculating component 1540 can include functions and instructions for calculating a first spatial routing and a first temporal routing through the reconfigurable fabric. The calculating component can further include functions and instructions for calculating a second spatial routing and a second temporal routing through the reconfigurable fabric. The spatial routing can be based on available interconnection paths, communications channels, switching elements, and the like, that can enable a path for communicating or transferring data and signals. The first or second spatial routings can enable logical connections for data transfer between or among pluralities of clusters within the reconfigurable fabric. The first or second temporal routing can enable a latency-aware data transfer between or among at least two clusters. The calculating spatial routing or temporal routing can be based on various criteria such as data needs, communication needs, or storage needs. The system 1500 can include an optimizing component 1550. The optimizing component 1550 can include functions and instructions for optimizing the first and second spatial routings and the first and second temporal routings. The optimizing can be based on the criteria discussed such as data, storage, or communication needs. The optimizing can be based further on reconfigurable fabric porosity. The optimization of the spatial and temporal routings can be accomplished using various techniques. In embodiments, the optimizing can place routing instructions in one or more clusters along a routing path within the reconfigurable fabric. The routing path can include unused L2 registers. In embodiments, the optimizing can prevent latency addition to the one or more functions. The prevention of latency addition can be accomplished by preloading or “pre-communicating” data through an available path so that the data is available when the function is ready to be executed. In embodiments, the optimizing can be based on a cluster porosity map.

The system 1500 can include an executing component 1560. The executing component 1560 can include functions and instructions for executing the one or more functions, using routings that were optimized. As discussed throughout, the functions can include logical functions, arithmetic functions, matrix operations, tensor operations, and the like. The functions can be performed on the data that is communicated to the functions using the optimized routings, data available in local storage such as direct memory access (DMA) storage, and the like. In embodiments, the one or more functions are implemented by kernels loaded into the plurality of clusters. The functions can be represented using other techniques. In embodiments, the one or more functions can be part of a data flow graph implemented in the reconfigurable fabric. The one or more functions can be part of a network, a Petri Net, etc.

The system 1500 can include a computer program product embodied in a non-transitory computer readable medium for data manipulation, the computer program product comprising code which causes one or more processors to perform operations of: allocating a plurality of clusters within a reconfigurable fabric, wherein the plurality of clusters is configured to execute one or more functions; calculating a first spatial routing and a first temporal routing through the reconfigurable fabric; calculating a second spatial routing and a second temporal routing through the reconfigurable fabric; optimizing the first and second spatial routings and the first and second temporal routings; and executing the one or more functions, using routings that were optimized.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for data manipulation comprising:
allocating a plurality of clusters within a reconfigurable fabric, wherein the plurality of clusters is configured to execute one or more functions;
calculating a first spatial routing and a first temporal routing through the reconfigurable fabric;
calculating a second spatial routing and a second temporal routing through the reconfigurable fabric;
optimizing the first and second spatial routings and the first and second temporal routings; and
executing the one or more functions, using routings that were optimized.

2. The method of claim 1 wherein the first spatial routing enables a logical connection for data transfer between at least two clusters of the plurality of clusters.

3. The method of claim 2 wherein the first temporal routing enables a latency-aware data transfer between the at least two clusters.

4. The method of claim 1 wherein the second spatial routing enables a logical connection for data transfer between at least two additional clusters of the plurality of clusters.

5. The method of claim 4 wherein the second temporal routing enables a latency-aware data transfer between the at least two additional clusters.

6. The method of claim 1 wherein the optimizing places routing instructions in one or more clusters along a routing path within the reconfigurable fabric.

7. The method of claim 6 wherein the routing instructions are placed in unused cluster control instruction locations within clusters of the reconfigurable fabric to enable spatial routing.

8. The method of claim 7 wherein the unused cluster control instruction locations are contained in instruction RAM (iRAM) instantiations.

9. The method of claim 8 further comprising utilizing an additional register between two of the iRAM instantiations to enable temporal routing.

10. The method of claim 9 wherein the additional register adds delay in routing instruction propagation within the reconfigurable fabric.

11. The method of claim 8 wherein the iRAM instantiations are included within L2 switches.

12. The method of claim 1 wherein the optimizing is a function of reconfigurable fabric porosity.

13. The method of claim 1 wherein the clusters implement co-processors within the reconfigurable fabric.

14. The method of claim 13 wherein the co-processors enable routing paths through the reconfigurable fabric.

15. The method of claim 1 wherein the optimizing prevents latency addition to the one or more functions.

16. The method of claim 1 wherein the one or more functions are implemented by kernels loaded into the plurality of clusters.

17. The method of claim 1 wherein the optimizing is based on a cluster porosity map.

18-27. (canceled)

28. The method of claim 1 further comprising calculating a third spatial routing and a third temporal routing through the reconfigurable fabric.

29. The method of claim 28 wherein the third spatial routing and the third temporal routing are further optimized with the first and second spatial routings and the first and second temporal routings.

30. The method of claim 29 wherein the first, second, and third spatial routings and the first, second, and third temporal routings are further optimized by rerunning the optimizing.

31. The method of claim 1 further comprising recalculating new first and second spatial routings and new first and second temporal routings based on a failure of the optimizing.

32. The method of claim 1 wherein the calculating a first spatial routing and a first temporal routing and the calculating a second spatial routing and a second temporal routing are based on a porosity map.

33. A computer program product embodied in a non-transitory computer readable medium for data manipulation, the computer program product comprising code which causes one or more processors to perform operations of:
allocating a plurality of clusters within a reconfigurable fabric, wherein the plurality of clusters is configured to execute one or more functions;
calculating a first spatial routing and a first temporal routing through the reconfigurable fabric;
calculating a second spatial routing and a second temporal routing through the reconfigurable fabric;
optimizing the first and second spatial routings and the first and second temporal routings; and
executing the one or more functions, using routings that were optimized.

34. A computer system for data manipulation comprising:
a memory which stores instructions;
one or more processors coupled to the memory wherein the one or more processors, when executing the instructions which are stored, are configured to:
allocate a plurality of clusters within a reconfigurable fabric, wherein the plurality of clusters is configured to execute one or more functions;
calculate a first spatial routing and a first temporal routing through the reconfigurable fabric;
calculate a second spatial routing and a second temporal routing through the reconfigurable fabric;
optimize the first and second spatial routings and the first and second temporal routings; and
execute the one or more functions, using routings that were optimized.
